(19) United States
(12) Patent Application Publication
(10) Pub. No.: US 2025/0031746 A1
(43) Pub. Date: Jan. 30, 2025

(54) Reduced or Zero Added Sodium Snack Food Pellets

(71) Applicant: Frito-Lay Trading Company GmbH, Berne (CH)

(72) Inventors: Rachel Duckworth, Berne (CH); David Jones, Berne (CH); Bhavnita Patel, Berne (CH); Roshni Patel, Berne (CH); Monica Talsania, Berne (CH)

(21) Appl. No.: 18/715,493

(22) PCT Filed: Nov. 30, 2021
(86) PCT No.: PCT/EP2022/083890

§ 371 Date: May 31, 2024

(30) Foreign Application Priority Data
Dec. 1, 2021 (GB) 2117360.4

(51) Int. Cl. A23P 30/20; A23L 7/13; A23P 30/38

(52) U.S. Cl. CPC A23P 30/20; A23L 7/13; A23P 30/38

(57) ABSTRACT

Methods for manufacturing reduced or zero added sodium expandable snack food pellets by controlling the manufacturing conditions to control the expansion ratio of the pellets. Methods for manufacturing reduced or zero added sodium expanded snack food by controlling the manufacturing conditions to control the bulk density of the resulting expanded snack food. Reduced or zero added sodium expandable snack food pellets having specific expansion ratio and/or glass transition temperature, and reduced or zero added sodium expanded snack food products prepared from the pellets. Reduced or zero added sodium expanded snack food having specific bulk density.

### FIELD OF THE INVENTION

The present invention relates to a reduced added sodium or zero added sodium snack food pellet for manufacturing an expanded snack food, a reduced added sodium or zero added sodium expanded snack food, and a method of manufacturing a reduced added sodium or zero added sodium expandable snack food pellet.

### BACKGROUND AND PRIOR ART

The use of snack food pellets to produce snack food products is well known in the art. The pellets are typically produced by extrusion and, upon cooking, the pellets expand to produce an expanded snack food.

Known snack food pellets typically include a high amount of added sodium. The sodium content of some known pellet compositions is 1-4%, which may come from sources such as sodium chloride, sodium bicarbonate and/or monosodium glutamate. For example, where the sodium source is sodium chloride, 2.4% sodium chloride equates to around 950 mg of sodium per 100 g of pellets. The amount of added sodium can vary between products. For example, expanded cereal snacks, such as Sabritones™ typically comprise 1445 mg of added sodium per 100 g of Sabritones™, whereas Bugles™ typically comprise 450-500 mg of added sodium per 100 g of Bugles™. Expanded potato based snacks, such as Quavers™, typically comprise 654 mg of added sodium per 100 g of Quavers™.

Added sodium is important in snack food pellets as it enables the formation of an expanded snack food product with a texture that is desirable to consumers. It is thought that this is because added sodium plays an important role in the expansion of snack food pellets. In addition, added sodium imparts a taste to the expanded snack food product which is desirable to consumers.

However, too much dietary sodium is not healthy and it is therefore desirable to produce lower sodium food products, especially snack food products. Ideally, the amount of sodium should be reduced to less than 300 mg of added sodium per 100 g of pellets and, more preferably, to zero added sodium.

However, it is not straightforward to remove sodium from pellets. Due to the role that sodium plays in expansion if sodium is simply removed the pellet tends to suffer from low or minimal expansion which leads to expanded products with high bulk density which may exhibit unexpanded glassy phases. Such products are undesirable to consumers.

Attempts have been made to compensate for the effect that added sodium has on pellet expansion by altering the composition of the starch matrix. For example, WO2015/118060 discloses adjusting the ratio of crystalline fraction to amorphous fraction in the starch matrix by adding in more amorphous starch to the starch composition such that the matrix has a higher concentration of amorphous starch which provides a starch mobility and water mobility in the amorphous regions which has a similar effect to the starch disruption provided by sodium and could therefore achieve comparable expansion.

However, such an approach involves adding in expensive functional starches such as N-Hance 59 which makes the method cost prohibitive. Therefore, what is needed is a method of compensating for the effects of sodium on expansion which can be readily applied to existing manufacturing methods in a cost effective, preferably cost neutral, manner.

### SUMMARY

In a first aspect, the invention provides a method for manufacturing a reduced or zero added sodium expandable snack food pellet comprising providing a dough comprising less than about 300 mg of added sodium per 100 g of dough; extruding the dough through an extruder to produce an extrudate; forming the extrudate into pellets; and drying the pellets, wherein the manufacturing conditions are controlled to increase the expansion ratio of the pellet by about 5% to about 45% relative to the same pellet manufactured under standard conditions.

In a second aspect, the invention provides a method for manufacturing a reduced or zero added sodium expanded snack food comprising providing a dough comprising less than about 300 mg of added sodium per 100 g of dough; extruding the dough through an extruder to produce an extrudate; forming the extrudate into pellets; drying the pellets; and cooking the pellets, wherein the manufacturing conditions are controlled to decrease the bulk density of the snack food by about 5% to about 40% relative to the same snack food manufactured under standard conditions.

In some embodiments, the manufacturing conditions are controlled by: a) increasing the temperature of the extruder relative to the temperature of an extruder used to extrude a dough comprising at least about 950 mg of added sodium per 100 g of dough; and/or b) increasing the speed of the extruder relative to the speed of an extruder used to extrude a dough comprising at least about 950 mg of added sodium per 100 g of dough; and/or c) decreasing the moisture content of the dough relative to a dough comprising at least about 950 mg of added sodium per 100 g of dough; and/or d) preconditioning the dough by steam injection before extrusion and increasing the amount of injected steam relative to the amount of injected steam used to precondition a dough comprising at least about 950 mg of added sodium per 100 g of dough.

In some embodiments, increasing the temperature of the extruder decreases the bulk density of the snack food by about 5% to about 30%, preferably about 10% to about 25%, more preferably about 15% to about 20%; and/or increases the expansion ratio of the snack food pellet by about 5% to about 30%, preferably about 10% to about 25%, more preferably about 15% to about 20%.

In some embodiments, increasing the speed of the extruder decreases the bulk density of the snack food by about 5% to about 20%, preferably about 10% to about 15%; and/or increases the expansion ratio of the snack food pellet by about 5% to about 20%, preferably about 10% to about 15%.

In some embodiments, decreasing the moisture content of the dough decreases the bulk density of the snack food by about 5% to about 15%, preferably about 7.5% to about 10%; and/or increases the expansion ratio of the snack food pellet by about 5% to about 15%, preferably about 7.5% to about 10%.

In some embodiments, increasing the amount of injected steam decreases the bulk density of the snack food by about 5% to about 20%, preferably about 10% to about 15%; and/or increases the expansion ratio of the snack food pellet by about 5% to about 40%, preferably about 10% to about 30%, more preferably about 15% to about 20%.

In some embodiments, the temperature of the extruder is increased by about 5% to about 45%, preferably about 7% to about 40%, more preferably about 8% to about 35%, even more preferably about 10% to about 30%, relative to the temperature of an extruder used to extrude a dough comprising at least about 950 mg of added sodium per 100 g of dough.

In some embodiments, the speed of the extruder is increased by about 5% to about 50%, preferably about 7% to about 45%, more preferably about 8% to about 40%, even more preferably about 10% to about 35%, relative to the speed of an extruder used to extrude a dough comprising at least about 950 mg of added sodium per 100 g of dough.

In some embodiments, the moisture content of the dough is decreased by about 0.5 wt % to about 6 wt %, preferably about 0.75 wt % to about 5 wt %, more preferably about 1 wt % to about 4 wt %, relative to a dough comprising at least about 950 mg of added sodium per 100 g of dough.

In some embodiments, the amount of steam injected is increased by about 1% to about 20%, more preferably about 3% to about 15%, even more preferably about 5% to about 10%, relative to the amount of injected steam used to precondition a dough comprising at least about 950 mg of added sodium per 100 g of dough.

In some embodiments, the temperature of the extruder may be increased by about 5° C. to about 50° C. relative to the temperature of an extruder used to extrude a dough comprising at least about 950 mg of added sodium per 100 g of dough.

In some embodiments, the speed of the extruder may be increased by about 10 rpm to about 40 rpm relative to the speed of an extruder used to extrude a dough comprising at least about 950 mg of added sodium per 100 g of dough.

In some embodiments, the dough comprises potato based starch. When the dough comprises potato based starch, the manufacturing conditions may be controlled by (i) increasing the temperature of the extruder by at least about 15%, preferably at least about 18%, relative to the temperature of an extruder used to extrude a dough comprising at least about 950 mg of added sodium per 100 g of dough; and/or (ii) increasing the speed of the extruder by at least about 20%, preferably at least about 25%, relative to the speed of an extruder used to extrude a dough comprising at least about 950 mg of added sodium per 100 g of dough. In these embodiments, the pellet may be described has having a heterogeneous starch-based matrix.

In some embodiments, the dough comprises grain based starch. When the dough comprises grain based starch, the manufacturing conditions may be controlled by (i) increasing the temperature of the extruder by at least about 5%, preferably 5.5%, relative to the temperature of an extruder used to extrude a dough comprising at least about 950 mg of added sodium per 100 g of dough; and/or (ii) increasing the speed of the extruder by at least about 8%, preferably 10%, relative to the speed of an extruder used to extrude a dough comprising at least about 950 mg of added sodium per 100 g of dough. In these embodiments, the pellet may be described as having a homogenous starch-based matrix.

In some embodiments, controlling the manufacturing conditions by, for example, increasing the temperature and/or speed of the extruder and/or decreasing the moisture content of the dough and/or increasing the amount of injected steam, lowers the glass transition temperature such that the extrudate has a lower glass transition temperature than the dough.

In some embodiments, the dough comprises less than about 250 mg, preferably less than about 200 mg, more preferably less than about 150 mg of added sodium per 100 g of dough. In some embodiments, the dough comprises zero added sodium per 100 g of dough.

In a third aspect, the invention provides a method for manufacturing a reduced or zero added sodium expandable snack food pellet comprising providing a dough comprising less than about 300 mg of added sodium per 100 g of dough; extruding the dough through an extruder to produce an extrudate; forming the extrudate into pellets; and drying the pellets, wherein the manufacturing conditions are controlled to provide a pellet having an expansion ratio which is about ±10%, preferably ±5%, of the expansion ratio of a comparable pellet comprising at least about 950 mg of added sodium per 100 g of pellets.

In a fourth aspect, the invention provides a method for manufacturing a reduced or zero added sodium expanded snack food comprising providing a dough comprising less than about 300 mg of added sodium per 100 g of dough; extruding the dough through an extruder to produce an extrudate; forming the extrudate into pellets; drying the pellets; and cooking the pellets, wherein the manufacturing conditions are controlled to provide a snack food having a bulk density which is about ±10%, preferably ±5% of the bulk density of a comparable snack food comprising at least about 950 mg of added sodium per 100 g of pellets.

In some embodiments, the manufacturing conditions are controlled by: a) increasing the temperature of the extruder relative to the temperature of an extruder used to extrude a dough comprising at least about 950 mg of added sodium per 100 g of dough; and/or b) increasing the speed of the extruder relative to the speed of an extruder used to extrude a dough comprising at least about 950 mg of added sodium per 100 g of dough; and/or c) decreasing the moisture content of the dough relative to a dough comprising at least about 950 mg of added sodium per 100 g of dough; and/or d) preconditioning the dough by steam injection before extrusion and increasing the amount of injected steam relative to the amount of injected steam used to precondition a dough comprising at least about 950 mg of added sodium per 100 g of dough.

In some embodiments, the temperature of the extruder is increased by about 5% to about 45%, preferably about 7% to about 40%, more preferably about 8% to about 35%, even more preferably about 10% to about 30%, relative to the temperature of an extruder used to extrude a dough comprising at least about 950 mg of added sodium per 100 g of dough.

In some embodiments, the speed of the extruder is increased by about 5% to about 50%, preferably about 7% to about 45%, more preferably about 8% to about 40%, even more preferably about 10% to about 35%, relative to the speed of an extruder used to extrude a dough comprising at least about 950 mg of added sodium per 100 g of dough.

In some embodiments, the moisture content of the dough is decreased by about 0.5 wt % to about 6 wt %, preferably about 0.75 wt % to about 5 wt %, more preferably about 1 wt % to about 4 wt %, relative to a dough comprising at least about 950 mg of added sodium per 100 g of dough.

In some embodiments, the amount of steam injected is increased by about 1% to about 20%, more preferably about 3% to about 15%, even more preferably about 5% to about 10%, relative to the amount of injected steam used to precondition a dough comprising at least about 950 mg of added sodium per 100 g of dough.

In some embodiments, the temperature of the extruder may be increased by about 5° C. to about 50° C. relative to the temperature of an extruder used to extrude a dough comprising at least about 950 mg of added sodium per 100 g of dough.

In some embodiments, the speed of the extruder may be increased by about 10 rpm to about 40 rpm relative to the speed of an extruder used to extrude a dough comprising at least about 950 mg of added sodium per 100 g of dough.

In some embodiments, the dough comprises potato based starch. When the dough comprises potato based starch, the manufacturing conditions may be controlled by (i) increasing the temperature of the extruder by at least about 15%, preferably at least about 18%, relative to the temperature of an extruder used to extrude a dough comprising at least about 950 mg of added sodium per 100 g of dough; and/or (ii) increasing the speed of the extruder by at least about 20%, preferably at least about 25%, relative to the speed of an extruder used to extrude a dough comprising at least about 950 mg of added sodium per 100 g of dough. In these embodiments, the pellet may be described has having a heterogeneous starch-based matrix.

In some embodiments, the dough comprises grain based starch. When the dough comprises grain based starch, the manufacturing conditions may be controlled by (i) increasing the temperature of the extruder by at least about 5%, preferably 5.5%, relative to the temperature of an extruder used to extrude a dough comprising at least about 950 mg of added sodium per 100 g of dough; and/or (ii) increasing the speed of the extruder by at least about 8%, preferably 10%, relative to the speed of an extruder used to extrude a dough comprising at least about 950 mg of added sodium per 100 g of dough. In these embodiments, the pellet may be described as having a homogenous starch-based matrix.

In some embodiments, controlling the manufacturing conditions by, for example, increasing the temperature and/or speed of the extruder and/or decreasing the moisture content of the dough and/or increasing the amount of injected steam, lowers the glass transition temperature such that the extrudate has a lower glass transition temperature than the dough.

In some embodiments, the dough comprises less than about 250 mg, preferably less than about 200 mg, more preferably less than about 150 mg of added sodium per 100 g of dough. In some embodiments, the dough comprises zero added sodium per 100 g of dough.

In a fifth aspect, the invention provides a reduced or zero added sodium expandable snack food pellet manufactured by the method described in the first and/or third aspects.

In a sixth aspect, there is provided reduced or zero added sodium expandable snack food pellet comprising less than about 300 mg added sodium per 100 g of pellets, wherein the pellet has a glass transition temperature of less than about 80° C., preferably less than about 70° C., more preferably less than about 60° C.

In a seventh aspect, there is provided a reduced or zero added sodium expandable snack food pellet comprising less than about 300 mg added sodium per 100 g of pellets, wherein the pellet has an expansion ratio which is about ±10%, preferably ±5%, of the expansion ratio of a comparable pellet comprising at least about 950 mg of added sodium per 100 g of pellets.

In an eighth aspect, there is provided an expanded snack food manufactured from the reduced or zero added sodium expandable snack food pellet according to any one of the fifth, sixth and/or seventh aspects.

In a ninth aspect, there is provided a method of manufacturing a reduced or zero added sodium expanded snack food, comprising providing a plurality of reduced or zero added sodium snack food pellets according to any one of the fifth, sixth and/or seventh aspects; and expanding the pellets during a cooking step to produce an expanded snack food; optionally wherein the cooking step comprises frying, baking, microwaving or popping.

In a tenth aspect, there is provided a reduced or zero added sodium expanded snack food, wherein the snack food has a bulk density which is about ±10%, preferably ±5%, of the bulk density of comparable snack food comprising at least about 950 mg of added sodium per 100 g of snack food.

In an eleventh aspect, there is provided a reduced or zero added sodium snack food manufactured by the method of any one of the second, fourth, eighth or nineth aspects.

### BRIEF DESCRIPTION OF THE FIGURES

FIGS. 1a and 1b are images showing the difference in colour between an expanded snack food manufactured from a standard added sodium pellet (1455 mg added sodium per 100 g of pellet)—FIG. 1a—and a reduced added sodium pellet (255 mg added sodium per 100 g of pellet)—FIG. 1b.

FIG. 2 is a graph showing texture evaluation via a sensory panel of standard, and reduced added sodium expanded snack food products. Market pellet containing 1455 mg added sodium per 100 g of pellets; Cell 3B containing 935 mg of added sodium per 100 g of pellets; Cell 5 containing 740 mg of added sodium per 100 g of pellets; Cell 1 containing 561 mg of added sodium per 100 g of pellets; and Cell 6 containing 255 mg of added sodium per 100 g of pellets.

FIG. 3 is a graph showing how bulk density changes with increasing extruder temperature.

FIG. 4 is a graph showing how expansion ratio changes with increased extruder temperature.

FIG. 5 is a graph showing how torque changes with increased extruder temperature.

FIG. 6 is a graph showing how torque changes with increased extruder speed.

FIG. 7 is a graph showing how torque changes with both increased extruder temperature and increased extruder speed.

FIG. 8 is a graph showing how bulk density changes with increased extruder speed.

FIG. 9 is a graph showing how expansion ratio changes with increased extruder speed.

FIG. 10 is a graph showing how bulk density changes with preconditioning by injection of steam.

FIG. 11 is a graph showing how expansion ratio changes with preconditioning by injection of steam.

FIG. 12 is a graph showing bulk density impact from pellets of differing moisture content.

FIG. 13 is a graph showing how bulk density changes with decreased dough moisture content.

FIG. 14 is a graph showing how torque changes with decreased dough moisture content.

FIG. 15 is a series of graphs showing the impact of removing sodium and of the different processing conditions on the modulus of pellets formed from the extrusion. Pellets containing 333 mg added sodium were compared with zero added sodium pellets. Under standard conditions (REF), removing added sodium increased the modulus of the pellets. Over processing (F) of the zero added sodium pellets reduced the modulus compared with the zero added sodium pellet manufactured under standard conditions.

FIG. 16 is a series of graphs showing the impact of removing sodium and of the different processing conditions on the microstructure characteristics of the fried products produced from the extruded pellets. Pellets containing 333 mg added sodium were compared with zero added sodium pellets. Under standard conditions (REF), removing added sodium decreased the cell size. Over processing (F) of the zero added sodium pellets increased the cell size compared with the zero added sodium pellet manufactured under standard conditions.

FIG. 17 is a series of graphs showing the impact of removing sodium and of the different processing conditions on the frying kinetics of the pellets. Pellets containing 333 mg added sodium were compared with zero added sodium pellets. Under standard conditions (REF), removing added sodium increased the time to expansion. Over processing (F) of the zero added sodium pellets reduced the time to expansion compared with the zero added sodium pellet manufactured under standard conditions.

FIG. 18 provides images of standard added sodium expanded snack food and zero added sodium expanded snack food manufactured according to an embodiment of the invention.

FIG. 19 is a graph showing the impact of differing mechanical shear and thermal processing on a zero added sodium chickpea pellet.

FIG. 20 provides images showcasing the differences in a zero added sodium chickpea fried pellet prepared by a variety of different mechanical shear and thermal processing conditions.

FIG. 21 is a sensory map depicting how increasing mechanical and thermal processing of zero added sodium chickpea pellets can improve product texture. Cell 1: Low Shear Screw Profile (Screw No. 3) at 100° C. and at 50 RPM; Cell 2: Low Shear Screw Profile (Screw No. 3) at 120° C. and at 80 RPM; Cell 3: Medium Shear Screw Profile (Screw No. 6) at 100° C. and at 60 RPM; Cell 4: Medium Shear Screw Profile (Screw No. 6) at 120° C. and at 80 RPM; Cell 5: High Shear Screw Profile (Screw No. 8) at 100° C. and at 60 RPM; Cell 6: High Shear Screw Profile (Screw No. 8) at 120° C. and at 80 RPM.

FIG. 22 is a graph showing how bulk density changes with increasing extruder temperature.

FIG. 23 is a graph showing how expansion ratio changes with increased extruder temperature.

### DETAILED DESCRIPTION

Known snack food pellets typically include added sodium to ensure that the pellets have good expansion when cooked, resulting in a snack food with a light and highly porous structure.

Sodium may be present in the pellets, dough used to manufacture the pellets, and/or in the final expanded snack food product in any form suitable for use in consumable food products. References herein to “added sodium” mean any sodium that has been added to the dough or pellets, i.e. sodium that is added beyond sodium that is naturally present in the ingredients of the dough/pellet. Sodium that is naturally present in the ingredients of the dough may be referred to herein as “trace sodium”. Examples of added sodium include sodium chloride, sodium bicarbonate and/or monosodium glutamate. Typically, the added sodium is sodium chloride and/or sodium bicarbonate. When an amount of sodium is referred to in this disclosure, it refers to the total amount of added sodium from all sources of added sodium.

Traditionally, pellets comprise 1.0-3.5 wt % added sodium which may come from sources such as sodium chloride, sodium bicarbonate and/or monosodium glutamate. This is approximately equivalent to 425 mg-2975 mg of added sodium per 100 g of pellet. Such pellets are referred to herein as “standard added sodium pellets” or “standard pellets”. Similarly, in a method for manufacturing an expandable snack food pellet, the dough used to manufacture the pellet typically comprises 1.0-3.5 wt % added sodium (425 mg-2975 mg per 100 g of pellet). Such doughs are referred to herein as “standard added sodium dough” or “standard dough”. Consequently, an expanded snack food produced from a standard pellet or standard dough typically comprises 1.0-3.5 wt % added sodium (425 mg-2975 mg per 100 g of expanded snack food product). Such a snack food is referred to herein as “standard added sodium expanded sodium snack food” or “standard expanded snack food”.

Reduced added sodium pellets according to the present disclosure comprise or contain less than about 300 mg of added sodium per 100 g of pellet (by dry weight). Preferably, the pellets comprise or contain less than about 275 mg, less than about 250 mg, less than about 225 mg, less than about 200 mg, less than about 175 mg, less than about 150 mg, less than about 125 mg, less than about 100 mg, less than about 75 mg, less than about 50 mg, or less than about 25 mg of added sodium per 100 g of pellet.

Alternatively, reduced added sodium pellets according to the present disclosure comprise or contain up to about 300 mg of added sodium per 100 g of pellet (by dry weight). Preferably, the pellets comprise or contain up to about 275 mg, up to about 250 mg, up to about 225 mg, up to about 200 mg, up to about 175 mg, up to about 150 mg, up to about 125 mg, up to about 100 mg, up to about 75 mg, up to about 50 mg, or up to about 25 mg of added sodium per 100 g of pellet.

Alternatively, reduced added sodium pellets according to the present disclosure comprise or contain between about Omg and 300 mg of added sodium per 100 g of pellet (by dry weight). For example, the pellets may comprise or contain between about 25 mg and 275 mg, or between about 50 mg and about 250 mg, or between about 75 mg and 225 mg, or between about 100 mg and about 200 mg, or between about 125 mg and 175 mg of added sodium per 100 g of pellet. Reduced added sodium expanded snack food according to the present disclosure comprises or contains less than about 300 mg of added sodium per 100 g of snack food (by dry weight). Preferably, the snack food comprises or contains less than about 275 mg, less than about 250 mg, less than about 225 mg, less than about 200 mg, less than about 175 mg, less than about 150 mg, less than about 125 mg, less than about 100 mg, less than about 75 mg, less than about 50 mg, or less than about 25 mg of added sodium per 100 g of snack food.

Alternatively reduced added sodium expanded snack food according to the present disclosure comprises or contains up to about 300 mg of added sodium per 100 g of snack food (by dry weight). Preferably, the snack food comprises or contains up to about 275 mg, up to about 250 mg, up to about 225 mg, up to about 200 mg, up to about 175 mg, up to about 150 mg, up to about 125 mg, up to about 100 mg, up to about 75 mg, up to about 50 mg, or up to about 25 mg of added sodium per 100 g of snack food.

Alternatively, reduced added sodium expanded snack food according to the present disclosure comprise or contain between about Omg and 300 mg of added sodium per 100 g of snack food (by dry weight). For example, the snack food may comprise or contain between about 25 mg and 275 mg, or between about 50 mg and about 250 mg, or between about 75 mg and 225 mg, or between about 100 mg and about 200 mg, or between about 125 mg and 175 mg of added sodium per 100 g of snack food.

300 mg of added sodium per 100 g of pellet, dough or expanded snack food product is approximately equivalent to 0.30 wt % (by dry weight). Therefore, in some embodiments, the reduced added sodium pellets comprise or contain less than about 0.30 wt % of added sodium by (dry) weight of the pellet. Preferably, the pellets comprise or contain less than about 0.275 wt %, less than about 0.25 wt %, less than about 0.225 wt %, less than about 0.2 wt %, less than about 0.175 wt %, less than about 0.15 wt %, less than about 0.125 wt %, less than about 0.10 wt %, less than about 0.075 wt %, less than about 0.05 wt %, or less than about 0.025 wt % of added sodium by (dry) weight of the pellet.

In some embodiments, the reduced added sodium expanded snack food product comprises or contains less than about 0.30 wt % of added sodium by (dry) weight of the snack food. Preferably, the snack food comprises or contains less than about 0.275 wt %, less than about 0.25 wt %, less than about 0.225 wt %, less than about 0.2 wt %, less than about 0.175 wt %, less than about 0.15 wt %, less than about 0.125 wt %, less than about 0.10 wt %, less than about 0.075 wt %, less than about 0.05 wt %, or less than about 0.025 wt % of added sodium by (dry) weight of the snack food.

Alternatively, the reduced added sodium pellets comprise or contain up to about 0.30 wt % of added sodium by (dry) weight of the pellet. Preferably, the pellets comprise or contain up to about 0.275 wt %, up to about 0.25 wt %, up to about 0.225 wt %, up to about 0.20 wt %, up to about 0.175 wt %, up to about 0.15 wt %, up to about 0.125 wt %, up to about 0.1 wt %, up to about 0.075 wt %, up to about 0.05 wt %, or up to about 0.025 wt % of added sodium by (dry) weight of the pellet.

In some embodiments, the reduced added sodium expanded snack food product comprises or contains up to about 0.30 wt % of added sodium by (dry) weight of the snack food. Preferably, the snack food comprises or contains up to about 0.275 wt %, about 0.25 wt %, about 0.225 wt %, about 0.20 wt %, about 0.175 wt %, about 0.15 wt %, about 0.125 wt %, about 0.1 wt %, about 0.075 wt %, about 0.05 wt %, or about 0.025 wt % of added sodium by (dry) weight of the snack food.

Alternatively, the reduced added sodium pellets (or reduced added sodium expanded snack food) comprise or contain between about 0 wt % and 0.30 wt % of added sodium by (dry) weight of the pellet. For example, the pellets may comprise or contain between about 0.025 wt % and 0.275 wt %, or between about 0.05 wt % and about 0.25 wt %, or between about 0.075 wt % and 0.225 wt %, or between about 0.1 wt % and about 0.2 wt %, of added sodium by (dry) weight of the pellet.

In some embodiments, the reduced added sodium expanded snack food product comprises or contains between about 0 wt % and 0.30 wt % of added sodium by (dry) weight of the snack food. For example, the snack food may comprise or contain between about 0.025 wt % and 0.275 wt %, or between about 0.05 wt % and about 0.25 wt %, or between about 0.075 wt % and 0.225 wt %, or between about 0.1 wt % and about 0.2 wt %, of added sodium by (dry) weight of the snack food.

In some embodiments, the snack food pellet is referred to as a zero added sodium snack food pellet. The term ‘zero added sodium’ means that there has been no sodium added to the pellet or dough. The pellet/dough may contain trace amounts of sodium that are naturally present in the ingredients of the dough, for example, potato flakes typically comprise about 80 mg sodium per 100 g; potato starch typically comprises about 16 mg sodium per 100 g; and cereal flours typically comprise about 5-20 mg sodium per 100 g.

In some embodiments, the snack food is referred to as a zero added sodium snack food. The term ‘zero added sodium’ means that there has been no sodium added to the pellet or dough used to manufacture the snack food. The snack food may contain trace amounts of sodium that are naturally present in the ingredients of the dough, as outlined above.

The present invention is at least partly predicated on the finding by the present inventors that when added sodium is present in a snack food pellet, the sodium plays an essential role in the expansion mechanism of the pellets during cooking. It is thought that the added sodium may have several roles, including modifying the moisture distribution, holding on to water within the pellet, lowering the glass transition temperature (T_{g}), acting as nucleation sites for expansion, increasing the expansion ratio and modifying the rheological properties of the matrix. This decreases the bulk density of the expanded snack food product in comparison to a reduced or zero added sodium expanded snack food.

As used herein, the term “expansion ratio” is the volume ratio between the dried pellet and the expanded snack food. Expansion ratio can be determined by volumetric (displacement) measurement. In the present disclosure, where a comparison is made between the expansion ratio of a reduced or zero added sodium snack food pellet according to the present disclosure and the same pellet manufactured under standard conditions, the same conditions are used to expand the pellets to produce an expanded snack food.

When added sodium is not present in a pellet, moisture is not distributed in the pellet in the same way, the glass transition temperature increases and the rheological strength of the matrix increases. In addition, the expansion ratio of the pellet decreases. This leads to a pellet that, when cooked, has poor expansion, a high bulk density and a texture that is undesirable to consumers—hard, crunchy and dense.

The inventors have surprisingly found that the effect of the absence or reduction of added sodium on expansion and/or bulk density can be mitigated in a reduced or zero added sodium pellet and/or expanded snack food by controlling the manufacturing conditions involved in manufacturing the pellet.

The manufacturing conditions may be controlled such that the bulk density of the reduced or zero added sodium expanded snack food is increased by about 5% to about 40%, preferably about 35% relative to the same snack food manufactured under standard conditions. Alternatively or additionally, the manufacturing conditions may be controlled such that the expansion ratio of the reduced or zero added sodium snack food pellet is increased by about 5% to about 45%, preferably about 40%, relative to the same pellet manufactured under standard conditions.

Alternatively or additionally, the manufacturing conditions may be controlled to provide a reduced or zero added sodium expanded snack food having a bulk density which is about +5% of the bulk density of a comparable snack food comprising at least about 950 mg sodium per 100 g of snack food.

Throughout the present disclosure, the term “at least” includes the start point of the range.

Alternatively or additionally, the manufacturing conditions may be controlled to provide a reduced or zero added sodium pellet having an expansion ratio which is about ±10%, preferably ±5%, of the expansion ratio of a comparable pellet comprising at least about 950 mg sodium per 100 g of pellets.

The term “manufacturing conditions” means any condition which can be controlled during the manufacture of a pellet. Examples include, but are not limited to, moisture content of the dough, preconditioning steps, extrusion conditions (temperature and/or speed) etc.

The term “same pellet” means a pellet which has the same composition as the reference pellet. The term “same snack food” means a snack food which has the same composition as the reference snack food.

The term “standard conditions” means the conditions used to manufacture a comparable standard added sodium pellet or a comparable standard added sodium expanded snack food. The term “comparable pellet” means a pellet which, with the exception of the amount of added sodium, has the same composition as the reference pellet. The term “comparable snack food” means a snack food which, with the exception of the amount of added sodium, has the same composition as the reference snack food.

As an example, the snack food product Sabritones™ is produced from a pellet comprising 1455 mg sodium per 100 g of Sabritones™ (a “standard added sodium pellet” for Sabritones™). The manufacturing conditions for a zero added sodium pellet for Sabritones™ may be controlled according to the present disclosure such that its bulk density is increased by about 5% to about 35% relative to the same pellet (a “zero added sodium pellet” for Sabritones™) which has been manufactured under conditions used to manufacture a standard added sodium pellet for Sabritones™.

In some embodiments, the manufacturing conditions that are controlled are the temperature of the extruder, the speed of the extruder, the moisture content of the dough, and/or preconditioning of the dough by steam injection.

In some embodiments the temperature of the extruder is increased relative to the temperature of an extruder used to extrude a dough comprising at least about 950 mg of added sodium per 100 g of dough. In some embodiments the speed of the extruder is increased relative to the speed of an extruder used to extrude a dough comprising at least about 950 mg of added sodium per 100 g of dough. In some embodiments, the moisture content of the dough is decreased relative to a dough comprising at least about 950 mg of added sodium per 100 g of dough. In some embodiments, the dough is preconditioned by steam injection before extrusion and the amount of injected steam is increased relative to the amount of injected steam used to precondition a dough comprising at least about 950 mg of added sodium per 100 g of dough.

It was surprisingly found that controlling the manufacturing conditions in this way could result in reduced or zero added sodium pellets which expand upon cooking to produce well expanded snack food product with favourable textural properties. It was expected that controlling such manufacturing conditions would lead to pellets which overexpand upon cooking giving a consistency of polystyrene which would be unpleasant to consume.

Using one or more of these controlled manufacturing conditions, the bulk density of a reduced or zero added sodium expanded snack food may be decreased by about 5% to about 40%, preferably about 35%, relative to the same reduced or zero added sodium snack food manufactured under standard conditions; and/or the expansion ratio of a reduced or zero added sodium snack food pellet may be increased by about 5% to about 45%, preferably about 40%, relative to the same reduced or zero added sodium pellet manufactured under standard conditions.

In some embodiments, under these controlled manufacturing conditions, the reduced or zero added sodium expanded snack food has a bulk density which is about ±5% of the bulk density of a comparable expanded snack food comprising at least about 950 mg sodium per 100 g of pellets and/or the reduced or zero added sodium pellet has an expansion ratio which is about ±5% of the expansion ratio of a comparable pellet comprising at least about 950 mg sodium per 100 g of pellets.

The increased expansion ratio of the snack food pellet results in expansion of the pellet during cooking in a comparable way to a standard added sodium pellet. In addition, the resultant snack food has a desirable bulk density. The present invention thus allows manufacture of an expanded snack food product which has reduced or zero added sodium but which has a texture comparable to a comparable standard added sodium expanded snack food product.

In some embodiments, under the controlled manufacturing conditions disclosed herein, the T_{g} of the reduced or zero added sodium pellet is decreased and the rheological properties of the matrix more closely resemble those of the standard added sodium pellet which leads to a pellet which can expand in a similar way to a standard added sodium pellet thus achieving a texture desired by consumers. This was unexpected as, typically, controlling manufacturing conditions by, for example, increasing the temperature and/or speed of an extruder when preparing a pellet would lead to an over processed pellet which upon frying expands to a consistency of polystyrene and is unpleasant to consume.

The present invention thus provides a method for manufacturing a reduced or zero added sodium expandable snack food pellet and a method for manufacturing a reduced or zero added sodium expanded snack food.

Expandable snack food pellets are pellets which expand upon cooking to form an expanded snack food of a desired shape and configuration. Various compositions of snack food pellets are known in the art. Typically, snack food pellets are produced by an extrusion process with a subsequent drying step. Cooking typically involves frying the pellets in oil.

### Dough Ingredients

The dough used in the present invention may be any dough used to prepare expanded snack food products, with the exception that the amount of added sodium is reduced or eliminated.

Typically, pellets are made from dough comprising starch. The starch component of the dough is the component that expands to the greatest extent to form the expanded snack food product. The starch component is therefore the component that is primarily affected by reducing or eliminating the amount of added sodium.

Any starch based ingredients suitable for forming pellets may be used in the present disclosure. The starch based ingredients may be, for example, potato, grain, legume (pulse) and/or root vegetable. If the starch based ingredient is potato, the ingredient may be in the form of potato dehydrates (e.g. native potato, potato flakes, potato isolates (fiber and protein) and/or potato granules), and/or potato starch. Where the starch based ingredient is a grain, the ingredient may be, for example, wheat, oat, rice (e.g. black rice, red rice), rye, barley, millet, quinoa, triticale, sorghum (e.g. white sorghum), spelt, or corn (maize), or a combination thereof. Where the starch based ingredient is a legume, the ingredient may be, for example, chickpea, pea (e.g. green pea, yellow pea), bean (e.g. black bean, green bean, soy bean etc), lentil (e.g. brown lentils, green lentils, red lentil, yellow lentils, black beluga lentils, puy lentils etc), flax seed, or a combination thereof. If the starch is a root vegetable, the ingredient may be cassava. The starch may also, or additionally be tapioca starch. The starch may also, or additionally be protein isolates (e.g. pea protein isolate),

The dough may include additional ingredients such as fillers (e.g. rice flour) flavours (e.g. yeast powder, onion powder), colours (e.g. annatto, curcumin), salt alternatives (e.g. potassium bicarbonate, potassium chloride), acids (e.g. citric acid) and/or fats (e.g. oil).

In a typical wheat-based dough used to manufacture a reduced added sodium pellet, the dough may comprise 98-99.5 wt % wheat flour, 0.1-1.0 wt % sodium chloride, 0-1.0 wt % sodium bicarbonate and 0-1.0 wt % other ingredients (fillers, flavours, colours, potassium bicarbonate, potassium chloride, citric acid and/or oil). Preferably, in a wheat-based dough, the dough comprises around 0.55 wt % sodium chloride and around 0.15 wt % sodium bicarbonate. In a typical wheat-based dough used to produce a zero added sodium pellet, the dough may comprise 99.8-100 wt % wheat flour and 0-0.2 wt % other ingredients such as colourings.

In a typical maize (corn) based dough used to manufacture a reduced added sodium pellet, the dough may comprise 98-99.5 wt % maize flour, 0.1-1.0 wt % sodium chloride, 0-1.0 wt % sodium bicarbonate and 0-1.0 wt % other ingredients (fillers, flavours, colours, potassium bicarbonate, potassium chloride, citric acid and/or oil). Preferably, in a maize-based dough, the dough comprises around 0.55 wt % sodium chloride and around 0.15 wt % sodium bicarbonate. In a typical maize-based dough used to produce a zero added sodium pellet, the dough may comprise 99.8-100 wt % maize flour and 0-0.2 wt % other ingredients such as colourings.

In a typical potato-based dough used to manufacture a reduced or zero added sodium pellet, the dough may comprise 10-97 wt % potato dehydrates (potato flakes and/or potato granules), 10-97 wt % potato starch, 0-1 wt % sodium chloride, 0-1.0 wt % sodium bicarbonate and 0-1.0 wt % other ingredients (fillers, flavours, colours, potassium bicarbonate, potassium chloride, citric acid and/or oil). Preferably, in a potato-based dough, the dough comprises at least 80 wt % potato based starch, around 0.55 wt % sodium chloride and around 0.15 wt % sodium bicarbonate. In a preferred recipe, the potato-based dough comprises around 0.2 wt % added sodium.

As outlined above, the starch component of the dough is the component that is primarily affected by reducing or eliminating the amount of added sodium. As the starch component is the main component of the dough, addressing the effect of sodium reduction on the starch component on bulk density and/or expansion by controlling the manufacturing conditions will lead to a pellet with better expansion properties (more closely resembling those of a standard added sodium pellet) regardless of what, if any, other components are included in the dough.

### Moisture Content

The doughs used in the present invention typically have a moisture content of 30-40 wt %. After drying, the dried pellets typically have a moisture content of 10-12 wt %.

It is generally understood that that expansion of pellets for manufacturing snack food products can be improved with increasing pellet moisture. However, it has surprisingly been discovered by the inventors that increasing the pellet moisture content only aids expansion up to a point, after which expansion of the pellet is negatively impacted. The inventors investigated whether decreasing the moisture content of the dough could increase expansion ratio of the resulting pellets manufactured from the dough and/or decrease the bulk density of the resulting expanded snack food. Surprisingly they found that this is indeed the case and therefore one of the manufacturing conditions that can be controlled in the present invention is the moisture content of the dough. Accordingly, the moisture content of a dough comprising less than about 300 mg of added sodium per 100 g of dough may be decreased relative to the moisture content of a dough comprising at least about 950 mg of added sodium per 100 g of dough.

In some embodiments, the moisture content of the reduced or zero added sodium dough is decreased by about 0.5 wt % to about 6 wt %, preferably about 0.75 wt % to about 5 wt %, more preferably about 1 wt % to about 4 wt %, more preferably still about 2 wt % to about 3 wt % relative to a dough comprising at least about 950 mg of added sodium per 100 g of dough.

In some embodiments the moisture content of the reduced or zero added sodium dough is decreased by at least about 2 wt %, or at least about 1.5 wt %, or at least about 1.0 wt %, or at least about 0.5 wt % relative to a dough comprising at least about 950 mg of added sodium per 100 g of dough. In some embodiments the moisture content of the reduced or zero added sodium dough is decreased by up to about 6 wt %, or up to about 5 wt %, or up to about 4 wt %, or up to about 3 wt % relative to a dough comprising at least about 950 mg of added sodium per 100 g of dough.

A standard added sodium pellet would typically have a moisture content of about 34 wt % to about 37 wt %. The moisture content of a reduced or zero added sodium dough according to the present disclosure might be reduced to about 33 wt %, or about 32 wt %, or about 31 wt %, or about 30 wt %.

Decreasing the moisture content of the reduced or zero added sodium dough relative to a dough comprising at least about 950 mg of added sodium per 100 g of dough can decrease the bulk density of the resulting reduced or zero added sodium expanded snack food by about 5% to about 15%, preferably about 7.5% to about 10% relative to the same snack food (i.e. a reduced or zero added sodium snack food) manufactured under standard conditions (i.e. conditions where the moisture content of the dough has not been decreased). In some embodiments the bulk density of such reduced or zero added sodium expanded snack food is comparable to the bulk density of standard added sodium expanded snack food.

Alternatively, decreasing the moisture content of the reduced or zero added sodium dough relative to a dough comprising at least about 950 mg of added sodium per 100 g of dough can decrease the bulk density of the resulting reduced or zero added sodium expanded snack food by up to about 15%, or up to about 12.5%, or up to about 10%, relative to the same expanded snack food (i.e. a reduced or zero added sodium snack food) manufactured under standard conditions. Similarly, decreasing the moisture content of the reduced or zero added sodium dough relative to a dough comprising at least about 950 mg of added sodium per 100 g of dough can decrease the bulk density of the resulting reduced or zero added sodium expanded snack food by at least about 5%, or at least about 7.5% relative to the same expanded snack food (i.e. a reduced or zero added sodium snack food) manufactured under standard conditions.

Decreasing the moisture content of the reduced or zero added sodium dough relative to a dough comprising at least about 950 mg of added sodium per 100 g of dough can increase the expansion ratio of the resulting reduced or zero added sodium pellet by about 5% to about 15%, preferably about 7.5% to about 10% relative to the same pellet (i.e. a reduced or zero added sodium) manufactured under standard conditions (i.e. conditions where the moisture content of the dough has not been decreased). In some embodiments the expansion ratio of such reduced or zero added sodium pellets is comparable to the bulk density of standard added sodium pellets.

Alternatively, decreasing the moisture content of the reduced or zero added sodium dough relative to a dough comprising at least about 950 mg of added sodium per 100 g of dough can increase the expansion ratio of the resulting reduced or zero added sodium pellet by up to about 15%, or up to about 12.5%, or up to about 10%, relative to the same pellet (i.e. a reduced or zero added sodium) manufactured under standard conditions (i.e. conditions where the moisture content of the dough as not been decreased). Similarly, decreasing the moisture content of the reduced or zero added sodium dough relative to a dough comprising at least about 950 mg of added sodium per 100 g of dough can increase the expansion ratio of the resulting reduced or zero added sodium pellet by at least about 5%, or at least about 7.5% relative to the same pellet (i.e. a reduced or zero added sodium) produced under standard conditions (i.e. conditions where the moisture content of the dough as not been decreased).

### Heterogeneous Pellets and Homogeneous Pellets

Pellets for producing snack food products can generally be classified into two main types, homogenous or heterogeneous, depending on their physical and microstructural characteristics. These different types of pellets expand in a different ways due to the physical and microstructural characteristics.

Homogeneous pellets are typically grain based. Cereal starches often need a lot more energy to process due to the integrity and make-up of the starch matrix. Therefore, in homogenous pellets, the structure of the starch based matrix has been heavily broken down during the processing to form the pellet. Typically, homogeneous pellets contain no intact starch structures, the matrix is much more uniform and the protein is distributed throughout the pellet. For homogeneous pellets, the expansion is driven by the properties of this heavily broken down, stretchy material or matrix. As the homogeneous pellet is heated (usually fried), the pressure of the steam generated causes the pellet to “blow” and fewer, large air bubbles are formed.

Heterogeneous pellets are typically potato based. Often, the potato used to form the pellet is pre-cooked (e.g. pre-cooked potato flakes or granules) and the starches therefore need less energy to process because they are already at least partially cooked. Heterogeneous pellets typically have an architecture dominated by the presence of fillers, e.g. swollen and crystalline starch granules. As the heterogeneous pellet is heated the filler particles act as nucleation points for bubble growth, these bubbles grow due to increasing pressure during frying, the kinetics of expansion are slower than homogeneous systems resulting in lots of small uniform bubbles in the expanded structure.

### Extruder Conditions

Manufacture of typical (standard added sodium) snack food pellets typically involves extruding the standard sodium snack food dough through an extruder and then forming the extrudate into pellets. The conditions for the extrusion need to be carefully monitored because over processing leads to over expansion upon subsequent cooking resulting in a product that resembles polystyrene which is unpleasant to consume and therefore undesirable to consumers. Standard added sodium pellets that are homogenous in nature can generally tolerate extrusion temperatures of 90° C. to 135° C. and extruder speeds (single screw extruder) of 80-370 rpm. Standard added sodium pellets that are heterogeneous in nature can generally tolerate extrusion temperatures of 55° C. to 90° C. and extruder speed (single screw extruder) of 18-80 rpm.

However, when reduced or zero added sodium pellets are manufactured under the conditions suitable for a standard added sodium pellet (standard conditions), the resulting pellet has poor expansion and provides a final product which has a texture that is hard, crunchy and dense. It is hypothesised that this could be due to the pellets having a stiffer/harder matrix which results in poor expansion, and which in turn leads to increased bulk density of the expanded snack food.

It has surprisingly been found that the effects of a stiffer/harder matrix of the reduced or zero added sodium pellets on expansion can be compensated for by increasing either the temperature of extrusion and/or the speed of extrusion. This was unexpected since it was thought that it would lead to pellets which overexpand on further processing.

Therefore, manufacturing conditions that can be controlled in the method for manufacturing a reduced or zero added sodium expandable snack food pellet include the temperature and/or speed of the extruder. In some embodiments therefore, the manufacturing conditions are controlled by increasing the temperature of the extruder relative to the temperature of an extruder used to extrude a dough comprising at least about 950 mg of added sodium per 100 g of dough. In some embodiments, the manufacturing conditions are controlled by increasing the speed of the extruder relative to the speed of an extruder used to extrude a dough comprising at least about 950 mg of added sodium per 100 g of dough.

### Extruder Temperature

Where the temperature of the extruder is increased, the increase may be by up to about 50%, preferably 45%, relative to the temperature of an extruder used to extrude a dough comprising at least about 950 mg of added sodium per 100 g of dough. For example, the increase may be up to about 40%, or up to about 35%, or up to about 30%, or up to about 25%, relative to the temperature of an extruder used to extrude a dough comprising at least about 950 mg of added sodium per 100 g of dough.

Alternatively, the temperature of the extruder may be increased by at least about 3% relative to the temperature of an extruder used to extrude a dough comprising at least about 950 mg of added sodium per 100 g of dough. For example, at least about 5%, or at least about 7%, or at least about 8%, or at least about 10%, relative to the temperature of an extruder used to extrude a dough comprising at least about 950 mg of added sodium per 100 g of dough.

Alternatively, the temperature of the extruder may be increased by about 5% to about 50%, preferably about 5% to about 45%, more preferably about 7% to about 40%, even more preferably about 8% to about 35%, even more preferably about 10% to about 30%, relative to the temperature of an extruder used to extrude a dough comprising at least about 950 mg of added sodium per 100 g of dough.

Increasing the temperature of the extruder relative to the temperature of an extruder used to extrude a dough comprising at least about 950 mg of added sodium per 100 g of dough can decrease the bulk density of the resulting reduced or zero added sodium expanded snack food by about 5% to about 40%, preferably about 5% to about 30%, more preferably about 10% to about 25%, even more preferably about 15% to about 20%, relative to the same expanded snack food (i.e. a reduced or zero added sodium snack food) manufactured under standard conditions, that is, conditions where the temperature of the extruder is the same as would be used to produce a standard added sodium pellet.

Alternatively, increasing the temperature of the extruder relative to the temperature of an extruder used to extrude a dough comprising at least about 950 mg of added sodium per 100 g of dough can decrease the bulk density of the resulting reduced or zero added sodium expanded snack food by up to about 40%, or up to about 35%, or up to about 30%, or up to about 25%, or up to about 20%, relative to the same expanded snack food (i.e. a reduced or zero added sodium snack food) manufactured under standard conditions. Similarly, increasing the temperature of the extruder relative to the temperature of an extruder used to extrude a dough comprising at least about 950 mg of added sodium per 100 g of dough can decrease the bulk density of the resulting reduced or zero added sodium expanded snack food by at least about 5%, or at least about 10%, or at least about 15% relative to the same expanded snack food (i.e. a reduced or zero added sodium snack food) manufactured under standard conditions. Increasing the temperature of the extruder relative to the temperature of an extruder used to extrude a dough comprising at least about 950 mg of added sodium per 100 g of dough can increase the expansion ratio of the resulting reduced or zero added sodium pellet by about 5% to about 45%, such as about 5% to about 40%, or about 5% to about 30%, preferably about 10% to about 25%, more preferably about 15% to about 20%, relative to the same pellet (i.e. a reduced or zero added sodium pellet) manufactured under standard conditions, that is, conditions where the temperature of the extruder is the same as would be used to produce a standard added sodium pellet.

Increasing the temperature of the extruder relative to the temperature of an extruder used to extrude a dough comprising at least about 950 mg of added sodium per 100 g of dough can increase the expansion ratio of the resulting reduced or zero added sodium pellet of up to about 45%, or up to about 40%, or about 30%, or up to about 25%, or up to about 20%, relative to the same pellet (i.e. a reduced or zero added sodium pellet) manufactured under standard conditions. Similarly, increasing the temperature of the extruder relative to the temperature of an extruder used to extrude a dough comprising at least about 950 mg of added sodium per 100 g of dough can increase the expansion ratio of the resulting reduced or zero added sodium pellet of at least about 5%, or at least about 10%, or at least about 15%, or at least about 20% relative to the same pellet (i.e. a reduced or zero added sodium pellet) manufactured under standard conditions.

If a dough comprises potato based starch, the dough typically contains ingredients that have been pre-cooked (potato dehydrates). The temperature of the extruder is therefore lower (55° C. to 90° C. as outlined above for a standard added sodium dough) as less energy is needed to process as the starch is already cooked. When a potato based dough is used to produce reduced or zero added sodium pellets, there is therefore scope to increase the temperature of the extruder. Consequently, when manufacturing a reduced or zero added sodium pellet from a potato-based dough, the temperature of the extruder is typically increased by at least about 15%, preferably at least about 18%, more preferably at least about 20% relative to the temperature of an extruder used to extrude a dough comprising at least about 950 mg of added sodium per 100 g of dough. The resulting reduced or zero added sodium pellets generally have a heterogenous starch-based matrix.

If a dough comprises grain-based starch, more energy is typically needed to process the dough. As such, the temperature of the extruder is higher (90° C. to 135° C. as outlined above for a standard added sodium dough). When a grain-based dough is used to produce reduced or zero added sodium pellet, there is therefore be less scope to increase the temperature of the extruder. Consequently, when manufacturing a reduced or zero added sodium pellet from a grain-based dough, the temperature of the extruder is typically increased by at least about 3%, preferably at least about 5%, at least about 5.5%, or at least about 6% relative to the temperature of an extruder used to extrude a dough comprising at least about 950 mg of added sodium per 100 g of dough. The resulting reduced or zero added sodium pellets generally have a homogenous starch-based matrix.

When manufacturing the reduced or zero added sodium pellets according to the present disclosure, the temperature of the extruder may be increased by about 5° C. to about 50° C., preferably about 10° C. to about 40° C., or about 20° C. to about 30° C. relative to the temperature of an extruder used to extrude a dough comprising at least about 950 mg of added sodium per 100 g of dough.

Alternatively, the temperature of the extruder may be increased by at least about 5° C., for example, at least about 10° C., about 15° C., or about 20° C., relative to the temperature of an extruder used to extrude a dough comprising at least about 950 mg of added sodium per 100 g of dough. Similarly, it could be said that the temperature of the extruder may be increased by up to about 50° C., for example, up to about 40° C., or about 30° C., relative to the temperature of an extruder used to extrude a dough comprising at least about 950 mg of added sodium per 100 g of dough.

For reduced or zero added sodium potato-based dough, the temperature of the extruder is typically increased by at least about 10° C. relative to the temperature of an extruder used to extrude a dough comprising at least about 950 mg of added sodium per 100 g of dough.

For reduced or zero added sodium cereal-based dough, the temperature of the extruder is typically increased by at least about 5° C. relative to the temperature of an extruder used to extrude a dough comprising at least about 950 mg of added sodium per 100 g of dough.

### Extruder Speed

Where the speed of the extruder is increased, the speed of the extruder is increased by about 5% to about 50% relative to the speed of an extruder used to extrude a dough comprising at least about 950 mg of added sodium per 100 g of dough. For example, the speed may be increased from about 7% to about 45%, or from about 8% to about 40%, or from about 10% to about 35% relative to the speed of an extruder used to extrude a dough comprising at least about 950 mg of added sodium per 100 g of dough.

Alternatively, the speed of the extruder is increased by at least about 5% relative to the speed of an extruder used to extrude a dough comprising at least about 950 mg of added sodium per 100 g of dough. For example, the speed of the extruder may be increased by at least about 7%, or at least about 8%, or at least about 10% relative to the speed of an extruder used to extrude a dough comprising at least about 950 mg of added sodium per 100 g of dough.

Alternatively, the speed of the extruder is increased by up to about 50% relative to the speed of an extruder used to extrude a dough comprising at least about 950 mg of added sodium per 100 g of dough. For example, the speed of the extruder may be increased by up to about 45%, or up to about 40%, or up to about 35% relative to the speed of an extruder used to extrude a dough comprising at least about 950 mg of added sodium per 100 g of dough.

Increasing the speed of the extruder relative to the speed of an extruder used to extrude a dough comprising at least about 950 mg of added sodium per 100 g of dough can decrease the bulk density of the resulting reduced or zero added sodium expanded snack food by about 5% to about 20%, preferably by about 7.5% to about 17.5%, more preferably by about 10% to about 15%, relative to the same expanded snack food (i.e. a reduced or zero added sodium snack food) manufactured under standard conditions, that is, conditions where the speed of the extruder is the same as would be used to produce a standard added sodium pellet.

Alternatively, increasing the speed of the extruder relative to the speed of an extruder used to extrude a dough comprising at least about 950 mg of added sodium per 100 g of dough can decrease the bulk density of the resulting reduced or zero added sodium expanded snack food by up to about 20%, or up to about 17.5%, or up to about 15%, relative to the same expanded snack food (i.e. a reduced or zero added sodium snack food) manufactured under standard conditions. Similarly, increasing the speed of the extruder relative to the speed of an extruder used to extrude a dough comprising at least about 950 mg of added sodium per 100 g of dough can decrease the bulk density of the resulting reduced or zero added sodium expanded snack food by at least about 5%, or at least about 7.5%, or at least about 10% relative to the same expanded snack food (i.e. a reduced or zero added sodium snack food) manufactured under standard conditions.

Increasing the speed of the extruder relative to the speed of an extruder used to extrude a dough comprising at least about 950 mg of added sodium per 100 g of dough can increase the expansion ratio of the resulting reduced or zero added sodium pellet by about 5% to about 20%, preferably by about 7.5% to about 17.5%, more preferably by about 10% to about 15%, relative to the same pellet (i.e. a reduced or zero added sodium pellet) manufactured under standard conditions, that is, conditions where the speed of the extruder is the same as would be used to produce a standard added sodium pellet.

Increasing the speed of the extruder relative to the speed of an extruder used to extrude a dough comprising at least about 950 mg of added sodium per 100 g of dough can increase the expansion ratio of the resulting reduced or zero added sodium pellet of up to about 20%, or up to about 17.5%, or up to about 15%, relative to the same pellet (i.e. a reduced or zero added sodium pellet) manufactured under standard conditions. Similarly, increasing the speed of the extruder relative to the speed of an extruder used to extrude a dough comprising at least about 950 mg of added sodium per 100 g of dough can increase the expansion ratio of the resulting reduced or zero added sodium pellet by at least about 5%, or at least about 7.5%, or at least about 10% relative to the same pellet (i.e. a reduced or zero added sodium pellet) manufactured under standard conditions.

If a dough comprises potato based starch, the dough typically contains ingredients that have already been pre-cooked (potato dehydrates). The speed of the extruder is therefore lower (typically 18 to 80 rpm for standard sodium dough) as less energy is needed to process as the starch is already cooked. When a potato based dough is used to produce reduced, or zero added sodium pellets there is, therefore, scope to increase the speed of the extruder. Consequently, when manufacturing a reduced or zero added sodium pellet from a potato-based dough, the speed of the extruder is typically increased by at least about 20%, preferably at least about 25%, at least about 30%, at least about 40%, or at least about 50%, or at least about 60%, relative to the speed of an extruder used to extrude a dough comprising at least about 950 mg of added sodium per 100 g of dough. The resulting reduced or zero added sodium pellets generally have a heterogenous starch-based matrix.

If a dough comprises grain-based starch, more energy is typically needed to process the dough. As such, the speed of the extruder is higher (typically 80 to 370 rpm for a standard sodium dough). When a grain-based dough is used to produce reduced, or zero added sodium pellets, there can therefore be less scope to increase the speed of the extruder. Consequently, when manufacturing a reduced or zero added sodium pellet from a grain-based dough, the speed of the extruder is typically increased by at least about 5%, preferably, at least about 8%, or at least about 10%, or at least about 12% relative to the speed of an extruder used to extrude a dough comprising at least about 950 mg of added sodium per 100 g of dough. The resulting reduced or zero added sodium pellets generally have a homogenous starch-based matrix.

When manufacturing the reduced or zero added sodium pellets according to the disclosure herein, the speed of the extruder may be increased by about 10 rpm to about 40 rpm, preferably by about 15 rpm to about 35 rpm, or by about 20 rpm to about 30 rpm relative to the speed of an extruder used to extrude a dough comprising at least about 950 mg of added sodium per 100 g of dough.

Alternatively, the speed of the extruder may be increased by at least about 10 rpm, preferably at least about 15 rpm, or at least about 20 rpm relative to the speed of an extruder used to extrude a dough comprising at least about 950 mg of added sodium per 100 g of dough. Similarly, it could be said that the speed of the extruder may be increased by up to about 40 rpm, preferably up to about 35 rpm, or up to about 30 rpm, relative to the speed of an extruder used to extrude a dough comprising at least about 950 mg of added sodium per 100 g of dough.

For reduced or zero added sodium potato-based dough, the speed of the extruder is typically increased by at least about 10 rpm, or at least about 15 rpm relative to the speed of an extruder used to extrude a dough comprising at least about 950 mg of added sodium per 100 g of dough.

For reduced or zero added sodium cereal-based dough, the speed of the extruder is typically increased by at least about 10 rpm, or at least about 15 rpm, relative to the speed of an extruder used to extrude a dough comprising at least about 950 mg of added sodium per 100 g of dough.

### Preconditioning

Manufacturing of expandable snack food products can involve one or more preconditioning steps before extrusion of the dough. A preconditioning step is typically useful to partially hydrate and/or partially gelatinise the dough before extrusion.

In some embodiments, one of the manufacturing conditions that can be controlled is preconditioning the dough by steam injection before extrusion and increasing the amount of injected steam relative to the amount of injected steam used to precondition a dough comprising at least about 950 mg of added sodium per 100 g of dough.

Often, no preconditioning by steam injection is undertaken when manufacturing a standard added sodium pellet. In this case, preconditioning the reduced or zero added sodium dough with any amount of injected steam constitutes an increase in the amount of injected steam relative to the amount of injected steam used to precondition a dough comprising at least about 950 mg of added sodium per 100 g of dough.

In some embodiments, the amount of steam injected is increased by about 1% to about 20%, more preferably about 3% to about 15%, even more preferably about 5% to about 10%, relative to the amount of injected steam used to precondition a dough comprising at least about 950 mg of added sodium per 100 g of dough.

Alternatively the amount of steam injected is increased by at least about 1%, preferably about 3%, more preferably about 5%, relative to the amount of injected steam used to precondition a dough comprising at least about 950 mg of added sodium per 100 g of dough.

Similarly, the amount of steam injected is increased by up to about 20%, preferably up to about 15%, more preferably up to about 10%, relative to the amount of injected steam used to precondition a dough comprising at least about 950 mg of added sodium per 100 g of dough.

The amount of steam used to precondition the dough may be up to about 10 wt % (on a dry weight basis), preferably, up to about 5 wt %. For example, if 100 kg of dry power ingredients per hour is being manufactured into pellets, the dough may be preconditioned with 5 kg of steam per hour.

Preconditioning the dough by steam injection and increasing the amount of injected steam relative to the amount of injected steam used to precondition a dough comprising at least about 950 mg of added sodium per 100 g of dough can decrease the bulk density of the resulting reduced or zero added sodium expanded snack food by about 5% to about 20%, preferably by about 7.5% to about 17.5%, more preferably by about 10% to about 15%, relative to the same expanded snack food (i.e. a reduced or zero added sodium snack food) manufactured under standard conditions, that is, conditions where the dough is not preconditioned by steam injection, or where the dough is preconditioned by an amount of steam injection that would be used to precondition a standard added sodium pellet.

Alternatively, preconditioning the dough by steam injection and increasing the amount of injected steam relative to the amount of injected steam used to precondition a dough comprising at least about 950 mg of added sodium per 100 g of dough can decrease the bulk density of the resulting reduced or zero added sodium expanded snack food by up to about 20%, or up to about 17.5%, or up to about 15%, relative to the same expanded snack food (i.e. a reduced or zero added sodium snack food) manufactured under standard conditions. Similarly, preconditioning the dough by steam injection and increasing the amount of injected steam relative to the amount of injected steam used to precondition a dough comprising at least about 950 mg of added sodium per 100 g of dough can decrease the bulk density of the resulting reduced or zero added sodium expanded snack food by at least about 5%, or at least about 7.5%, or at least about 10% relative to the same expanded snack food (i.e. a reduced or zero added sodium snack food) manufactured under standard conditions.

Preconditioning the dough by steam injection and increasing the amount of injected steam relative to the amount of injected steam used to precondition a dough comprising at least about 950 mg of added sodium per 100 g of dough can increase the expansion ratio of the resulting reduced or zero added sodium pellet by about 5% to about 40%, preferably by about 10% to about 30%, more preferably by about 15% to about 20%, relative to the same pellet (i.e. a reduced or zero added sodium pellet) manufactured under standard conditions, that is, conditions where the dough is not preconditioned by steam injection, or where the dough is preconditioned by an amount of steam injection that would be used to precondition a standard added sodium pellet.

Preconditioning the dough by steam injection and increasing the amount of injected steam relative to the amount of injected steam used to precondition a dough comprising at least about 950 mg of added sodium per 100 g of dough can increase the expansion ratio of the resulting reduced or zero added sodium pellet of up to about 40%, or up to about 35%, or up to about 30%, or up to about 25%, or up to about 20% relative to the same pellet (i.e. a reduced or zero added sodium pellet) manufactured under standard conditions. Similarly, preconditioning the dough by steam injection and increasing the amount of injected steam relative to the amount of injected steam used to precondition a dough comprising at least about 950 mg of added sodium per 100 g of dough can increase the expansion ratio of the resulting reduced or zero added sodium pellet by at least about 5%, or at least about 7.5%, or at least about 10%, or at least about 12.5%, or at least about 15% relative to the same pellet (i.e. a reduced or zero added sodium pellet) manufactured under standard conditions.

### Pellet Properties

Controlling the manufacturing conditions used to manufacture a reduced or zero added sodium expandable snack food pellet according to the present disclosure may produce a pellet with properties approaching those of a standard added sodium pellet. For example:

### Expansion Ratio

As discussed above, it is desirable to manufacture a reduced or zero added sodium pellet which has an expansion ratio closely resembling that of a standard added sodium pellet. Therefore, in some embodiments, there is provided a reduced or zero added sodium expandable snack food pellet comprising less than about 300 mg added sodium per 100 g of pellets, wherein the pellet has an expansion ratio which is about ±10%, preferably ±5%, of the expansion ratio of a pellet comprising at least about 950 mg of added sodium per 100 g of pellets.

Expansion ratio is the volume ratio between the dried pellet and the expanded snack food. Expansion ratio can be determined by volumetric (displacement) measurement.

Typically, a standard added sodium pellet has an expansion ratio of about 3 to about 8. When a reduced or zero added sodium is prepared under the same manufacturing conditions as a standard sodium pellet (i.e. under standard conditions), the expansion ratio decreases to about 1.2 to about 5. This leads to a poorly expanded product which has a texture that is undesirable to consumers.

When the reduced or zero added sodium pellets are manufactured under controlled manufacturing conditions according to the present disclosure (e.g. increased temperature and/or speed of the extruder, and/or decreased moisture content of the dough and/or preconditioning by steam injection), the expansion ratio increases to about 3 to about 6. As this is within the range of expansion ratio of the standard added sodium pellet, the reduced or zero added sodium expanded snack food product much more closely resembles that produced from a standard sodium pellet and has better textural characteristics.

In some embodiments therefore, controlling the manufacturing conditions when manufacturing a reduced or zero added sodium pellet increases the expansion ratio such that the reduced or zero added sodium pellet has a higher expansion ratio than the same pellet (i.e. a reduced or zero added sodium pellet) pellet would have if manufactured under standard conditions. In preferred embodiments, increasing the temperature and/or speed of the extruder and/or decreasing the moisture content of the dough and/or increasing the amount of injected steam increases the expansion ratio such that the reduced or zero added sodium pellet has a higher expansion ratio than the same pellet (i.e. a reduced or zero added sodium pellet) would have if manufactured under standard conditions. In another preferred embodiment, increasing the temperature and/or speed of the extruder and/or decreasing the moisture content of the dough and/or increasing the amount of injected steam increases the expansion ratio such that the reduced or zero added sodium pellet has a comparable expansion ratio to a standard added sodium pellet.

In some embodiments there is provided a reduced or zero added sodium expandable snack food pellet comprising less than about 300 mg added sodium per 100 g of pellets, wherein the pellet has an expansion ratio of about 3 to about 6, preferably about 4 to about 5.

In some embodiments, the pellet has an expansion ratio of up to about 6, preferably up to about 5. It can also be said that the pellet has an expansion ratio of at least about 3, or at least about 4.

### Glass Transition Temperature

The glass transition temperature of the dough T_{g} is an important measure that correlates to dough stiffness/flexibility. The glass transition temperature is an indicator of where the material begins to demonstrate flow; or alternately where a plastic, flexible material is beginning to acquire more solid like behaviour. The glass transition temperature is an indicator of where the change in material properties begins. In general, the higher T_{g} is inversely related to dough flexibility. Therefore, as the amount of added sodium is reduced and the glass transition temperature increases, so the rheological strength of the matrix increases. The matrix become stiffer leading to poorer expansion.

The glass transition temperature can be determined by any means suitable. For example by dynamic mechanical analysis (DMA), in particular DMA-7 using a Perkin-Elmer three-point blending test. This analysis uses a heating rate of 10° C. per minute, a temperature scan of 25-150° C., a Constant Stress Frequency of 1 Hz and a PTFE sheet.

A standard added sodium pellet typically has a T_{g} of about 55 to about 80° C. When a reduced or zero added sodium is prepared under the same manufacturing conditions as a standard sodium pellet (i.e. under standard conditions), the T_{g} increases to about 80 to about 125° C. This in turn increases the rheological strength of the matrix which leads to poor expansion and provides a final product which has a texture that is hard, crunchy and dense.

When the reduced or zero added sodium pellets are manufactured under controlled manufacturing conditions according to the present disclosure (e.g. increased temperature and/or speed of the extruder, and/or decreased moisture content of the dough and/or preconditioning by steam injection), the T_{g} of the pellet is reduced to less than about 80° C., preferably less than about 70° C., more preferably, between about 60° C. and about 70° C. As this is within the range of T_{g} of the standard added sodium pellet, the reduced or zero added sodium expanded snack food product much more closely resembles that produced from a standard added sodium pellet and has better textural characteristics.

In some embodiments therefore, controlling the manufacturing conditions when manufacturing a reduced or zero added sodium pellet lowers the glass transition temperature such that the extrudate has a lower glass transition temperature than the dough. In preferred embodiments, increasing the temperature and/or speed of the extruder and/or decreasing the moisture content of the dough and/or increasing the amount of injected steam lowers the glass transition temperature such that the extrudate has a lower glass transition temperature than the dough. It can also be said that controlling the manufacturing conditions when manufacturing a reduced or zero added sodium pellet lowers the glass transition temperature such that the reduced or zero added sodium extrudate has a lower glass transition temperature than the same extrudate (i.e. a reduced or zero added sodium exudate) would have if manufactured under standard conditions. In preferred embodiments, increasing the temperature and/or speed of the extruder lowers the glass transition temperature such that the reduced or zero added sodium extrudate has a lower glass transition temperature than the same extrudate (i.e. a reduced or zero added sodium extrudate) would have if manufactured under standard conditions (lower extruder temperature and/or speed). In another preferred embodiment, increasing the temperature and/or speed of the extruder lowers the glass transition temperature such that the reduced or zero added sodium extrudate has a comparable glass transition temperature to a standard added sodium extrudate.

In some embodiments therefore, there is provided a reduced or zero added sodium expandable snack food pellet comprising less than about 300 mg added sodium per 100 g of pellets, wherein the pellet has a glass transition temperature of less than about 80° C., preferably less than about 70° C., more preferably less than about 60° C.

It can alternatively be said that there is provided a reduced or zero added sodium expandable snack food pellet comprising less than about 300 mg added sodium per 100 g of pellets, wherein the pellet has a glass transition temperature of up to about 80° C., preferably up to about 70° C., more preferably up to about 60° C.

### Tensile Strength

Tensile strength is defined as the “resistance to lengthwise stress, measured by the greatest load in weight per unit area pulling in the direction of length that a given substance can bear without tearing apart”. Removal of sodium from a pellet leads to an increase rheological strength of the matrix and, in turn, an increase in tensile strength. Controlling the manufacturing conditions (e.g. increased temperature and/or speed of the extruder, and/or decreased moisture content of the dough and/or preconditioning by steam injection) when manufacturing the reduced or zero added sodium pellets, decreases the tensile strength towards a value of a standard sodium pellet. It is thought that this might be because the increased processing conditions breaks down the molecular weight of the starch based matrix thereby reducing the tensile strength of the matrix.

The tensile strength can be determined by any means suitable, for example using Instron Universal Testing Machine (5.500R6025), Instron Oven Tensile tests at high temperatures 100° C., 6 mm/min, 5 replicates/recipe.

A standard sodium pellet typically has a tensile strength of about 0.8 to about 4.5 MPa. When a reduced or zero added sodium is prepared under the same manufacturing conditions as a standard sodium pellet (i.e. standard conditions), the tensile strength increases to about 1 to about 12 MPa. This in turn increases the rheological strength of the matrix which leads to poor expansion and provides a final product which has a texture that is hard, crunchy and dense. When the reduced or zero added sodium pellets are manufactured under the controlled manufacturing conditions according to the present disclosure (e.g. increased temperature and/or speed of the extruder, and/or decreased moisture content of the dough and/or preconditioning by steam injection), the tensile strength of the pellet can be reduced to about 1.5 to about 10 MPa.

In some embodiments therefore, controlling the manufacturing conditions when manufacturing a reduced or zero added sodium pellet lowers the tensile strength such that the extrudate has a lower tensile strength than the dough. In preferred embodiments, increasing the temperature and/or speed of the extruder and/or decreasing the moisture content of the dough and/or increasing the amount of injected steam lowers the tensile strength such that the extrudate has a lower tensile strength than the dough. It can also be said that controlling the manufacturing conditions when manufacturing a reduced or zero added sodium pellet lowers the tensile strength such that the reduced or zero added sodium extrudate has a lower tensile strength than the same extrudate (i.e. a reduced or zero added sodium extrudate) would have if manufactured under standard conditions. In preferred embodiments, increasing the temperature and/or speed of the extruder lowers the tensile strength such that the reduced or zero added sodium extrudate has a lower tensile strength than the same extrudate (i.e. a reduced or zero added sodium extrudate) would have if manufactured under standard conditions (lower extruder temperature and/or speed). In another preferred embodiment, increasing the temperature and/or speed of the extruder lowers tensile strength such that the reduced or zero added sodium extrudate has a comparable tensile strength to a standard added sodium extrudate.

In some embodiments therefore, there is provided a reduced or zero added sodium expandable snack food pellet comprising less than about 300 mg added sodium per 100 g of pellets, wherein the pellet has a tensile strength of less than about 4.5 MPa.

### Modulus

Modulus, or the tensile modulus, evaluates the elasticity of a material and the power needed to deform it. It measures stiffness of a material. Removal of sodium from a pellet leads to an increase rheological strength of the matrix and, in turn, an increase in tensile modulus. As for tensile strength above, controlling the manufacturing conditions (e.g. increased temperature and/or speed of the extruder, and/or decreased moisture content of the dough and/or preconditioning by steam injection) when manufacturing the pellets, decreases the tensile modulus towards a value of a standard added sodium pellet. It is thought that this might be because the increased processing conditions break down the molecular weight of the starch based matrix thereby reducing the tensile modulus of the matrix.

The modulus can be determined by any suitable means. For example, using Instron Universal Testing Machine (5.500R6025), Instron Oven Tensile tests at high temperatures 100° C., 6 mm/min, 5 replicates/recipe.

A standard added sodium pellet typically has a modulus of about 40 to about 140 MPa. When a reduced or zero added sodium is prepared under the same manufacturing conditions as a standard sodium pellet (i.e. standard conditions), the tensile strength increases to about 100 to about 240 MPa. This in turn increases the rheological strength of the matrix which leads to poor expansion and provides a final product which has a texture that is hard, crunchy and dense. When the reduced or zero added sodium pellets are manufactured according to the present disclosure (e.g. increased temperature and/or speed of the extruder, and/or decreased moisture content of the dough and/or preconditioning by steam injection), the modulus of the pellet is reduced to about 60 to about 190 MPa.

In some embodiments therefore, controlling the manufacturing conditions when manufacturing a reduced or zero added sodium pellet lowers the modulus such that the extrudate has a lower modulus than the dough. In preferred embodiments, increasing the temperature and/or speed of the extruder and/or decreasing the moisture content of the dough and/or increasing the amount of injected steam lowers the modulus such that the extrudate has a lower modulus than the dough. It can also be said that controlling the manufacturing conditions when manufacturing a reduced or zero added sodium pellet lowers the modulus such that the reduced or zero added sodium extrudate has a lower tensile strength than the same extrudate (i.e. a reduced or zero added sodium extrudate) would have if manufactured under standard conditions. In preferred embodiments, increasing the temperature and/or speed of the extruder lowers the modulus such that the reduced or zero added sodium extrudate has a lower modulus than the same extrudate (i.e. a reduced or zero added sodium extrudate) would have if manufactured under standard conditions (lower extruder temperature and/or speed). In another preferred embodiment, increasing the temperature and/or speed of the extruder lowers the modulus such that the reduced or zero added sodium extrudate has a comparable modulus to a standard added sodium extrudate.

In some embodiments therefore, there is provided a reduced or zero added sodium expandable snack food pellet comprising less than about 300 mg added sodium per 100 g of pellets, wherein the pellet has a modulus of less than about 140 MPa.

### Time to Expansion

Time to expansion refers to the time taken between the pellets being subjected to cooking conditions (generally frying) and the time to when expansion begin (initial bubble formation). Removal of sodium from a pellet leads to an increased time to expansion. It is thought that this is because, as sodium is removed and the rheological strength of the matrix increases, the matrix become stiffer. A stiffer matrix has an increased brittle-ductile transition temperature meaning more energy is required to expand the product. The matrix therefore requires more heating to reach the point where it is ductile enough to expand. This equates to an increased time to expansion.

There is no standardised way to measure time to expansion, it is typically determined by recording the frying of the pellet and making a visual judgement on when expansion begins.

A standard added sodium pellet typically has a time to expansion of about 25 to about 40 seconds (at a measurement temperature of about 130° C. to about 150° C.). When a reduced or zero added sodium is prepared under the same manufacturing conditions as a standard added sodium pellet (i.e. standard conditions), the time to expansion increases to about 90 seconds (at a measurement temperature of about 130° C. to about 150° C.). When the reduced or zero added sodium pellets are manufactured according to the present disclosure (e.g. increased temperature and/or speed of the extruder, and/or decreased moisture content of the dough and/or preconditioning by steam injection), the time to expansion of the pellet is reduced to about 60 seconds (at a measurement temperature of about 130° C. to about 150° C.). As this is much closer to the time to expansion for a standard added sodium pellet, the reduced or zero added sodium expanded snack food product much more closely resembles that produced from a standard added sodium pellet with better textural characteristics.

In some embodiments therefore, controlling the manufacturing conditions when manufacturing a reduced or zero added sodium pellet lowers the time to expansion such that the reduced or zero added sodium pellet has a lower time to expansion than the same pellet (i.e. a reduced or zero added sodium pellet) would have if manufactured under standard conditions. In preferred embodiments, increasing the temperature and/or speed of the extruder and/or decreasing the moisture content of the dough and/or increasing the amount of injected steam lowers the time to expansion such that the reduced or zero added sodium pellet has a lower time to expansion than the same pellet (i.e. a reduced or zero added sodium pellet) would have if manufactured under standard conditions.

In another preferred embodiment, increasing the temperature and/or speed of the extruder and/or decreasing the moisture content of the dough and/or increasing the amount of injected steam lowers the time to expansion such that the reduced or zero added sodium pellet has a comparable time to expansion to a standard added sodium pellet.

In some embodiments there is provided a reduced or zero added sodium expandable snack food pellet comprising less than about 300 mg added sodium per 100 g of pellets, wherein the pellet has a time to expansion of less than about 60 seconds when fried at about 130° C. to about 150° C.

### Expanded Snack Food Properties

Controlling the manufacturing conditions used to manufacture a reduced or zero added sodium expandable snack food pellet according to the present disclosure may result in the production of an expanded snack food with properties approaching those of a standard added sodium expanded snack food. For example:

### Bulk Density

As discussed above, it is desirable to manufacture a reduced or zero added sodium expanded snack food which has a bulk density closely resembling that of a standard added sodium expanded snack food. Therefore, in some embodiments, there is provided a reduced or zero added sodium expandable snack food pellet, wherein the snack food has a bulk density which is about ±5% of the bulk density of a comparable snack food comprising at least about 950 mg of added sodium per 100 g of snack food.

When sodium is removed from (or not added to) a pellet, the bulk density of the expanded snack food produced from the pellet increases. This is undesirable because a denser expanded snack food has a texture that is hard, crunchy and dense.

Bulk density can be measured by placing the product into a 5L transparent plastic beaker until full and allowing the product of the beaker to settle. The weight of the product is then recorded and the bulk density is calculated by dividing the weight (g) by the volume (L).

Typically, a standard added sodium expanded snack food has a bulk density of about 35 to about 50 g/L. When a reduced or zero added sodium pellet is prepared under the same manufacturing conditions as a standard sodium pellet (i.e. under standard conditions), the bulk density of the resulting expanded snack food increases to about 50 to about 60 g/L. This leads to a product which has a texture that is undesirable to consumers.

When the reduced or zero added sodium pellets are manufactured under controlled manufacturing conditions according to the present disclosure (e.g. increased temperature and/or speed of the extruder, and/or decreased moisture content of the dough and/or preconditioning by steam injection), the bulk density of the resulting expanded snack food decreases to about 40 to about 50 g/L, preferably, about 45 to about 50 g/L. As this is within the range of bulk density of the standard added sodium expanded snack food, the reduced or zero added sodium expanded snack food product much more closely resembles that produced from a standard sodium pellet and has better textural characteristics.

In some embodiments therefore, controlling the manufacturing conditions when manufacturing a reduced or zero added sodium pellet decreases the bulk density such that the reduced or zero added sodium expanded snack food has a lower bulk density than the same expanded snack food (i.e. a reduced or zero added sodium snack food) would have if manufactured under standard conditions. In preferred embodiments, increasing the temperature and/or speed of the extruder and/or decreasing the moisture content of the dough and/or increasing the amount of injected steam decreases the bulk density such that the reduced or zero added sodium expanded snack food has a lower bulk density than the same expanded snack food (i.e. a reduced or zero added sodium snack food) would have if manufactured under standard conditions. In another preferred embodiment, increasing the temperature and/or speed of the extruder and/or decreasing the moisture content of the dough and/or increasing the amount of injected steam decreases the bulk density such that the reduced or zero added sodium expanded snack food has a comparable bulk density to a standard added sodium expanded snack food.

In some embodiments there is provided a reduced or zero added sodium expanded snack food, wherein the expanded snack food has a bulk density of about 40 g/L to about 50 g/L, preferably about 45 g/L to about 50 g/L.

In some embodiments, the expanded snack food has an bulk density of less than about 50 g/L, preferably about 45 g/L.

### Post Extrusion

Once the extrudate has been produced, it is formed into pellets. This may be undertaken by any method known in the art and the pellets may take any desired shape and/or configuration.

The pellets are then dried. The pellets may be dried by any technique used to dry standard pellets. Typical conditions for drying are 45° C., 65% humidity for 5 hours.

The dried pellets may be expanded during a cooking step to produce a reduced or zero added sodium expanded snack food. The pellets may be expanded by any method known in the art. In some embodiments, the cooking step comprises frying, baking, microwaving or popping. These pellet expansion methods would be known to persons skilled in the art of snack food manufacture.

In some embodiments therefore, there is provided a method of producing a reduced or zero added sodium expanded snack food, comprising providing a plurality of reduced or zero added sodium snack food pellets as described herein; and expanding the pellets during a cooking step to produce an expanded snack food; optionally wherein the cooking step comprises frying, baking, microwaving or popping.

In some cases, it is possible to gain an additional improvement in the texture of the reduced or zero added sodium snack food products by frying the pellets under optimised conditions. It has surprisingly been found that increasing the frying temperature by about 5° C. to about 20° C. when frying reduced or low added sodium pellets relative to the temperature used to fry standard added sodium pellets can result in an expansion ratio, bulk density and product texture that is comparable to standard added sodium snack food products. This was unexpected because increasing the frying temperature for a standard added sodium pellet would be expected to cause browning/burning of the pellets, form process contaminants (acrylamide) and lead to oil quality deterioration.

### EXAMPLES

The following examples are specific embodiments of the present invention but are not intended to limit the present invention.

### Example 1

A standard sodium containing dough was prepared comprising 96.07% wheat flour, 0.98% sodium bicarbonate and 2.95% sodium chloride. The dough contained added 1455 mg sodium per 100 g of dough. A reduced added sodium containing dough was also prepared comprising 99.32% wheat flour, 0.13% sodium bicarbonate and 0.55% sodium chloride. This dough contained 255 mg added sodium per 100 g.

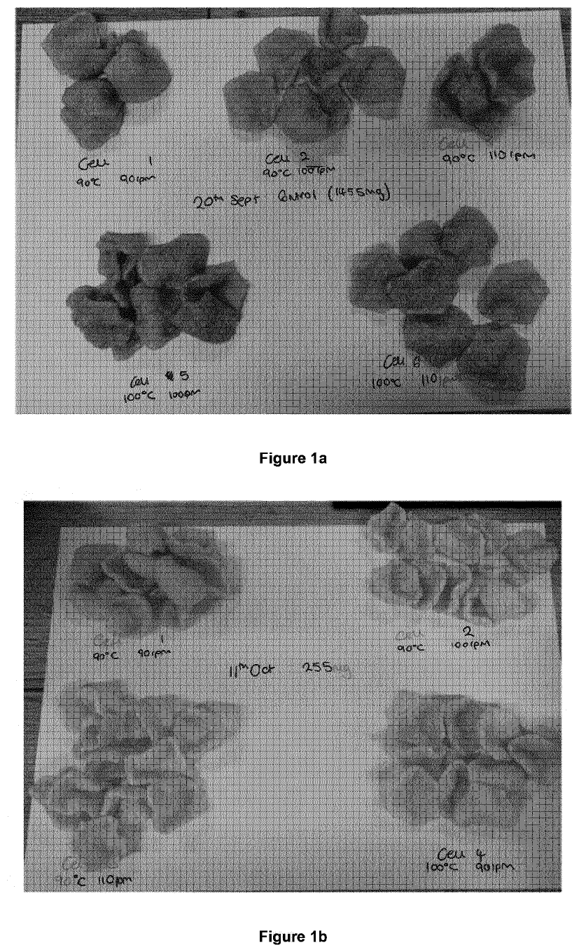

Both doughs were extruded under standard conditions (at 90° C. and 90 rpm) and formed into pellets. Upon frying the pellets at 185° C. for 20 seconds, it was found that the bubble structure of the reduced sodium pellets was smaller than that of the standard sodium pellets. The colour of the reduced sodium pellet and the resulting expanded snack food was extremely pale in comparison to the standard sodium pellet and expanded snack food. FIGS. 1a (standard sodium) and 1b (reduced sodium) show the differences in colour.

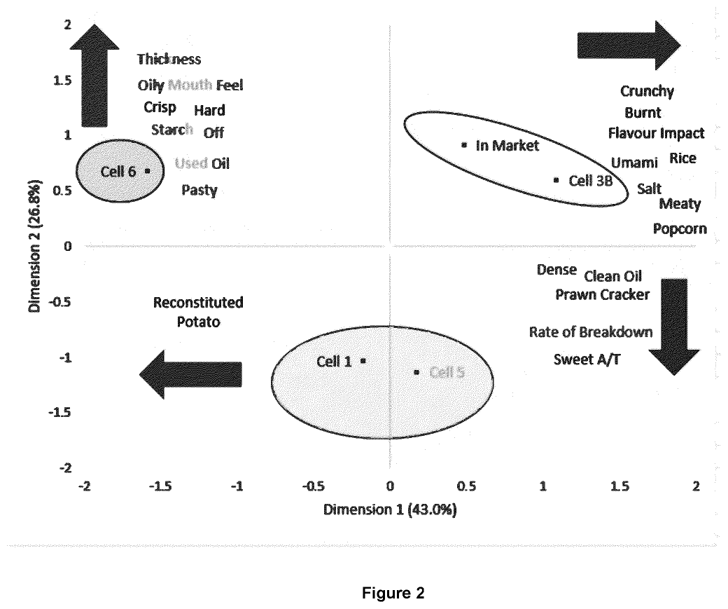

The texture of the standard and reduced sodium snack food pellets was also tested via a sensory panel (FIG. 2). For this assessment, three further reduced sodium pellets were prepared such that the pellets assessed were as follows:
Market pellet containing 1455 mg added sodium per 100 g of pellets;
Cell 3B containing 935 mg of added sodium per 100 g of pellets (97.5% wheat flour, 2% sodium chloride, 0.5% sodium bicarbonate);
Cell 5 containing 740 mg of added sodium per 100 g of pellets (97.5% wheat flour, 0.5% sodium chloride, 2% sodium bicarbonate);
Cell 1 containing 561 mg of added sodium per 100 g of pellets (98.5% wheat flour, 1.2% sodium chloride, 0.3% sodium bicarbonate); and
Cell 6 containing 255 mg of added sodium per 100 g of pellets.

The data in FIG. 2 shows that when the amount of added sodium is reduced from a pellet with no compensation for the effect that added sodium has on pellet expansion, the resulting expanded snack food is hard, crunchy and has a slower breakdown rate in the mouth.

### Example 2

Using the doughs comprising 1455 mg added sodium and 255 mg added sodium prepared in Example 1, the impact of controlling the manufacturing conditions by increasing the temperature of the extruder used to extrude the doughs on bulk density of the resulting expanded snack food was investigated.

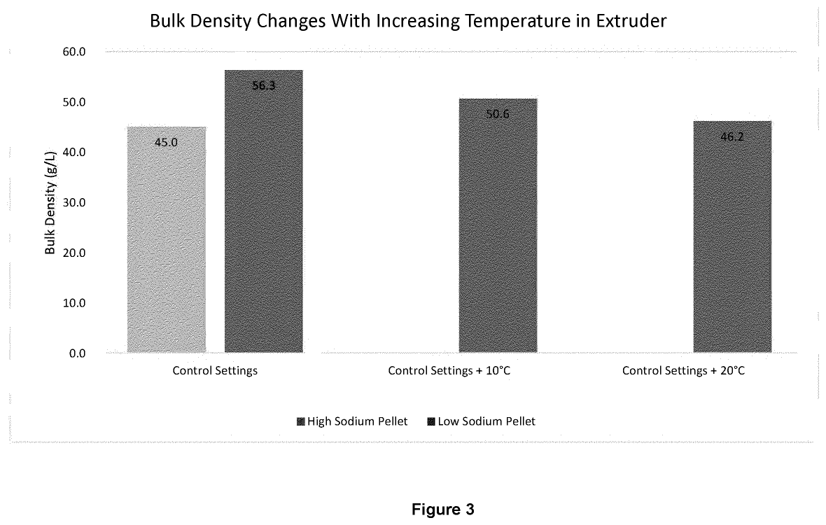

FIG. 3 shows the results of this example. Standard conditions are shown in FIG. 3 as “Control Settings”. These control settings were extrusion at 90° C. and 90 rpm. When the standard added sodium dough is extruded under the control settings, the resulting expanded snack food (after frying at 185° C. for 20 seconds) had a bulk density of about 45.0 g/L. When the reduced added sodium dough was extruded under the control settings, the resultant expanded snack food had an increased bulk density of about 56.3 g/L.

For optimum expansion, it is desirable that the bulk density of the reduced added sodium expanded snack food is as close as possible to that of the standard added sodium expanded snack food, preferably within about 5%. To try to achieve this, the temperature of the extruder was increased by 10° C. to 100° C., an increase of 11% compared to the control setting. This resulted in the bulk density of the reduced added sodium expanded snack food being decreased to about 50.6 g/L, a decrease of about 10.1% compared with the same reduced added sodium snack food manufactured under standard conditions. This reduction in bulk density results in reduced added sodium expanded snack food with a bulk density about 12.5% higher than that of the standard added sodium expanded snack food.

It was desirable to achieve a bulk density for the reduced added sodium expanded snack food that more closely resembled that of the standard added sodium expanded snack food. Therefore, the temperature of the extruder was increased further, this time by 20° C. to 110° C., an increase of 22% compared to the control setting. This resulted in the bulk density of the reduced added sodium expanded snack food being decreased to about 46.2 g/L, a decrease of about 17.9% compared with the same reduced added sodium expanded snack food manufactured under standard conditions. This reduction in bulk density results in reduced added sodium expanded snack food with a bulk density about 2.7% higher than that of the standard added sodium expanded snack food.

Expansion of the reduced added sodium pellets extruded under manufacturing conditions controlled by increasing the temperature of the extruder by 20° C. (22%) compared to standard conditions provided expanded snack food products with surface and internal bubble structure that was larger and much more closely resembled the structure of standard added sodium pellets. It was also found that reduced added sodium pellets extruded under increased temperature conditions resulted in expanded snack food products that break down faster in the mouth, much more like standard added sodium expanded snack food products.

### Example 3

Using the doughs comprising 1455 mg added sodium and 255 mg added sodium prepared in Example 1, the impact of controlling the manufacturing conditions by increasing the temperature of the extruder used to extrude the doughs on expansion ratio of the resulting pellets was investigated.

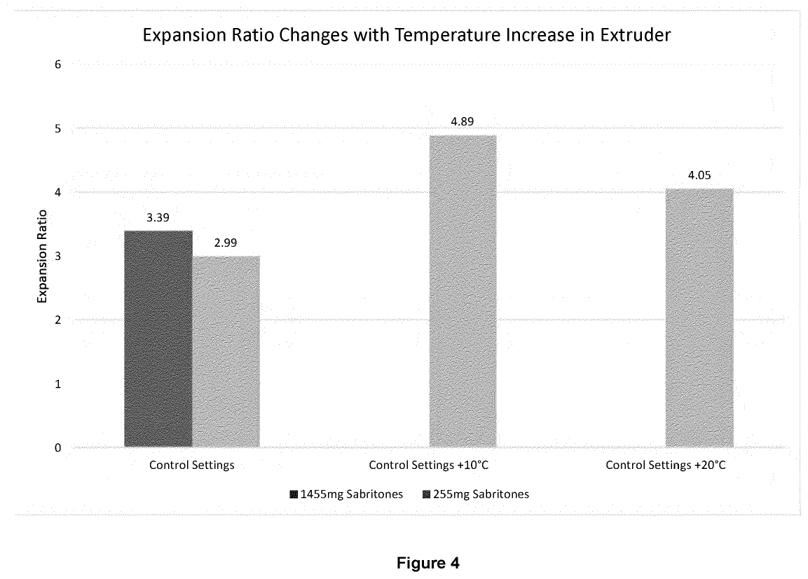

FIG. 4 shows the results of this example. Standard conditions are shown in FIG. 4 as “Control Settings”. These control settings were extrusion at 90° C. and 90 rpm. When the standard added sodium dough is extruded under the control settings, the resulting pellets had an expansion ratio of about 3.39. When the reduced added sodium dough was extruded under the control settings, the resultant pellets had a decreased expansion ratio of about 2.99.

For optimum expansion, it is desirable that the expansion ratio of the reduced added sodium pellets is as close as possible to that of the standard added sodium pellets, preferably within about 5%. To try to achieve this, the temperature of the extruder was increased by 10° C. to 100° C., an increase of 11.1% compared to the control setting. This resulted in the expansion ratio of the reduced added sodium pellets increasing to about 4.89, an increase of about 63.5% compared with the same reduced added sodium pellets manufactured under standard conditions. This increase in expansion ratio results in reduced added sodium pellets with an expansion ratio of about 44.2% higher than that of the standard added sodium pellets.

It was desirable to achieve an expansion ratio for the reduced added sodium pellets that more closely resembled that of the standard added sodium pellets. Therefore, the temperature of the extruder was increased further, this time by 20° C. to 110° C., an increase of 22.2% compared to the control setting. This resulted in the expansion ratio of the reduced added sodium pellets being increased to about 4.05, an increase of about 35.5% compared with the same reduced added sodium pellets manufactured under standard conditions. This reduction in expansion ratio results in reduced added sodium pellets with an expansion ratio about 19.5% higher than that of the standard added sodium pellets. Although this is higher than ideally desired, these pellets do not result in poor expanded snack food products, only different ones.

Expansion of the reduced added sodium pellets extruded under manufacturing conditions controlled by increasing the temperature of the extruder by 20° C. (22.2%) compared to standard conditions provided expanded snack food products with surface and internal bubble structure that was larger and much more closely resembled the structure of standard added sodium pellets. It was also found that reduced added sodium pellets extruded under increased temperature conditions resulted in expanded snack food products that break down faster in the mouth, much more like standard added sodium expanded snack food products.

### Example 4

In this example, it was investigated why controlling the manufacturing conditions by increasing the temperature of the extruder results in reduced added sodium pellets more closely resembling standard added sodium pellets.

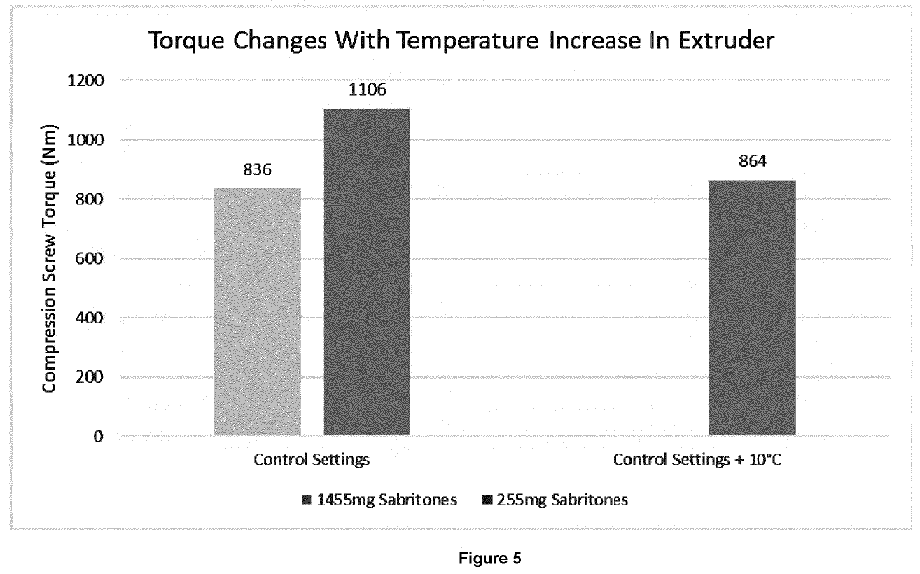

It was hypothesised that the rheology of the dough changes when added sodium is removed or reduced. This results in an extruder screw requiring more force to turn when less added sodium is present. Increasing the temperature in the extruder barrel helps to change the rheological properties of the dough such that the amount of force required is reduced. This is demonstrated in FIG. 5 which shows that the torque increases from 836 Nm to 1106 nM when added sodium is removed from the dough (1455 mg added sodium compared with 255 mg added sodium). Increasing the temperature of the extruder by 10° C. then decreases the torque required to extrude the reduced added sodium dough to 864 Nm, much more closely resembling that of the standard added sodium pellets.

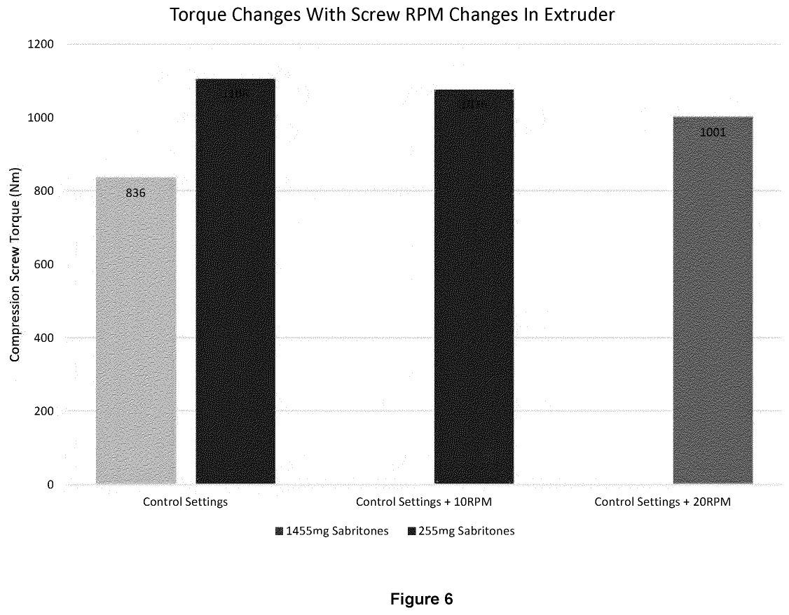

FIG. 6 shows the torque changes with extruder speed (rpm) changes. Increasing the rpm of the extruder by about 10 rpm or about 20 rpm decreases the torque required to extrude the reduced added sodium dough to 1076 Nm and 1001 Nm respectively, more closely resembling that of the standard added sodium pellets.

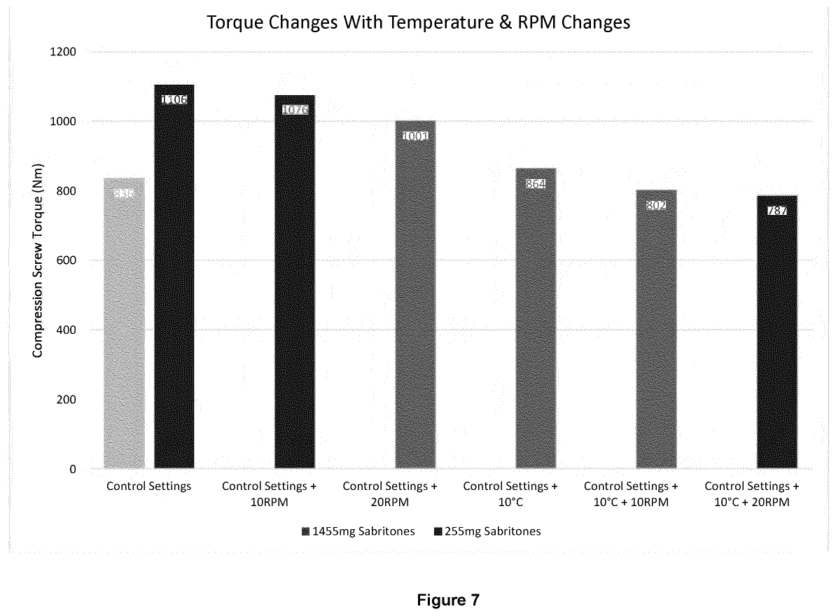

Similarly, FIG. 7 shows Increasing the rpm by about 10 rpm or about 20 rpm and increasing the temperature by about 10° C. further reduces the torque to within about 4% to about 6% of the torque required to extrude standard added sodium dough.

### Example 5

Using the doughs comprising 1455 mg added sodium and 255 mg added sodium prepared in Example 1, the impact of controlling the manufacturing conditions by increasing the speed of the extruder used to extrude the doughs on bulk density of the resulting expanded snack food was investigated.

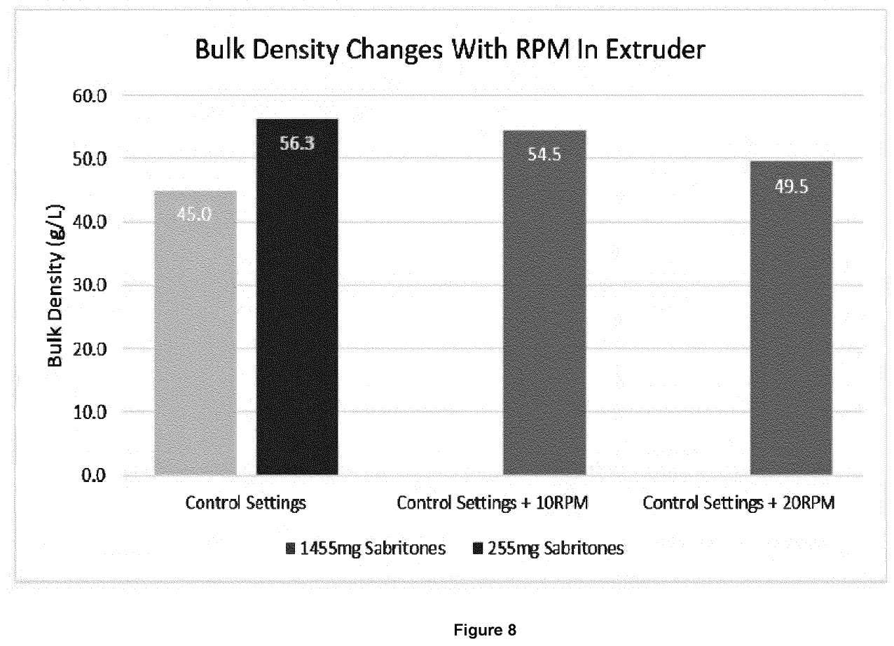

FIG. 8 shows the results of this example. Standard conditions are shown in FIG. 8 as “Control Settings”. These control settings were extrusion at 90° C. and 90 rpm. When the standard added sodium dough is extruded under the control settings, the resulting expanded snack food (after frying at 185° C. for 20 seconds) had a bulk density of about 45.0 g/L. When the reduced added sodium dough was extruded under the control settings, the resultant expanded snack food had an increased bulk density of about 56.3 g/L.

For optimum expansion, it is desirable that the bulk density of the reduced added sodium expanded snack food is as close as possible to that of the standard added sodium expanded snack food, preferably within about 5%. To try to achieve this, the speed of the extruder was increased by 10 RPM to 100 RPM, an increase of 11% compared to the control setting. This resulted in bulk density of the reduced added sodium expanded snack food being decreased to about 54.5 g/L, a decrease of about 3.2% compared with the same reduced added sodium expanded snack food manufactured under standard conditions. This reduction in bulk density results in reduced added sodium expanded snack food with a bulk density about 21.1% higher than that of the standard added sodium expanded snack food.

It was desirable to achieve a bulk density for the reduced added sodium expanded snack food that more closely resembled that of the standard added sodium expanded snack food. Therefore, the speed of the extruder was increased further, this time by 20 RPM to 110 RPM, an increase of 22% compared to the control setting. This resulted in bulk density of the reduced added sodium expanded snack food being decreased to about 49.5 g/L, a decrease of about 12.1% compared with the same reduced added sodium expanded snack food manufactured under standard conditions. This reduction in bulk density results in reduced added sodium expanded snack food with a bulk density about 10% higher than that of the standard added sodium expanded snack food.

Expansion of the reduced added sodium pellets extruded under manufacturing conditions controlled by increasing the speed of the extruder by 10 RPM (11%) compared to standard conditions provided expanded snack food products with surface and internal bubble structure that was larger and much more closely resembled the structure of standard added sodium pellets. It was also found that reduced added sodium pellets extruded under increased temperature conditions resulted in expanded snack food products that break down faster in the mouth, much more like standard added sodium expanded snack food products.

### Example 6

Using the doughs comprising 1455 mg added sodium and 255 mg added sodium prepared in Example 1, the impact of controlling the manufacturing conditions by increasing the speed of the extruder used to extrude the doughs on expansion ratio of the resulting pellets was investigated.

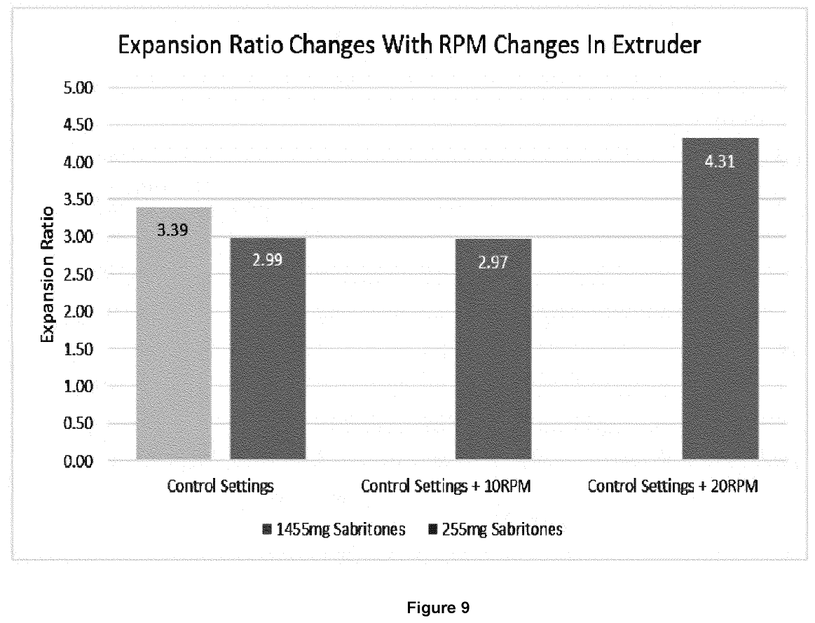

FIG. 9 shows the results of this example. Standard conditions are shown in FIG. 9 as “Control Settings”. These control settings were extrusion at 90° C. and 90 rpm. When the standard added sodium dough is extruded under the control settings, the resulting pellets had an expansion ratio of about 3.39. When the reduced added sodium dough was extruded under the control settings, the resultant pellets had a decreased expansion ratio of about 2.99.

For optimum expansion, it is desirable that the expansion ratio of the reduced added sodium pellets is as close as possible to that of the standard added sodium pellets, preferably within about 5%. To try to achieve this, the speed of the extruder was increased by about 10 rpm to 100 rpm, an increase of 11.1% compared to the control setting. This resulted in the expansion ratio of the reduced added sodium pellets decreasing slightly to about 2.97. As this was not the desired increase in expansion ratio, the speed of the extruder was increased further, this time by about 20 rpm to 110 rpm, an increase of 22.2% compared to the control setting.

This greater increase in speed resulted in the expansion ratio of the reduced added sodium pellets being increased to about 4.31, an increase of about 44.1% compared with the same reduced added sodium pellets manufactured under standard conditions. This reduction in expansion ratio results in reduced added sodium pellets with an expansion ratio about 27.1% higher than that of the standard added sodium pellets. Although this is higher than ideally desired, these pellets do not result in poor expanded snack food products, only different ones.

Expansion of the reduced added sodium pellets extruded under manufacturing conditions controlled by increasing the temperature of the extruder by about 10 rpm (11.1%) compared to standard conditions provided expanded snack food products with surface and internal bubble structure that was larger and much more closely resembled the structure of standard added sodium pellets. It was also found that reduced added sodium pellets extruded under increased temperature conditions resulted in expanded snack food products that break down faster in the mouth, much more like standard added sodium expanded snack food products.

### Example 7

Using the doughs comprising 1455 mg added sodium and 255 mg added sodium prepared in Example 1, the impact of controlling the manufacturing conditions by preconditioning the dough by steam injection before extrusion and increasing the amount of injected steam relative to the amount of injected steam used to precondition a standard added sodium dough bulk density of the resulting expanded snack food was investigated.

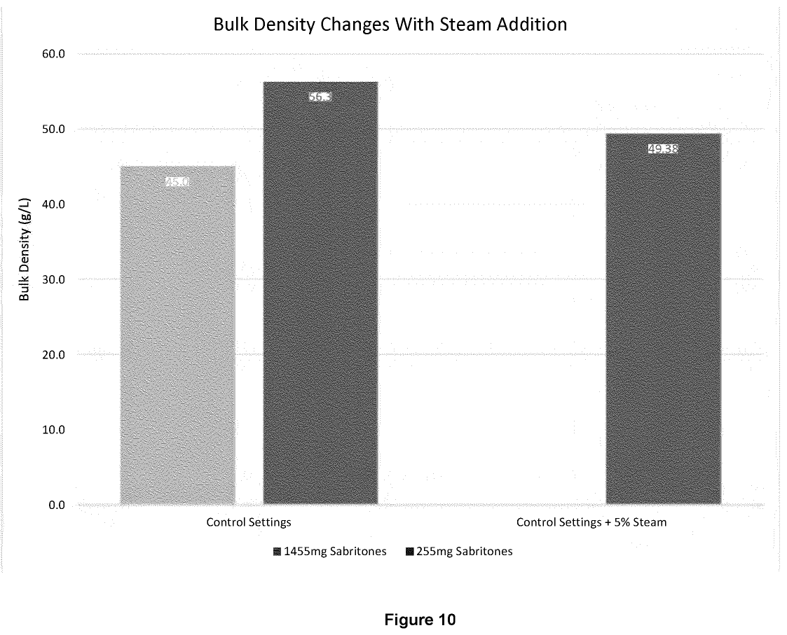

FIG. 10 shows the results of this example. Standard conditions are shown in FIG. 10 as “Control Settings”. These control settings were extrusion at 90° C. and 90 rpm (no steam preconditioning). When the standard added sodium dough is extruded under the control settings, the resulting expanded snack food (after frying at 185° C. for 20 seconds) had a bulk density of about 45.0 g/L. When the reduced added sodium dough was extruded under the control settings, the resultant expanded snack food had an increased bulk density of about 56.3 g/L.

For optimum expansion, it is desirable that the bulk density of the reduced added sodium expanded snack food is as close as possible to that of the standard added sodium expanded snack food, preferably within about 5%. To try to achieve this, the reduced added sodium dough was preconditioned with the injection of about 5% steam (on a dry weight basis). This resulted in bulk density of the reduced added sodium expanded snack food being decreased to about 49.38 g/L, a decrease of about 12.3% compared with the same reduced added sodium expanded snack food manufactured under standard conditions. This reduction in bulk density results in reduced added sodium expanded snack food with a bulk density about 9.7% higher than that of the standard added sodium expanded snack food.

Expansion of the reduced added sodium pellets extruded under manufacturing conditions controlled by preconditioning the dough by adding about 5% steam injection before extrusion had a similar impact to increasing the temperature of the extruder. The resulting pellets produced expanded snack food products with quicker break down in mouth and softer texture.

### Example 8

Using the doughs comprising 1455 mg added sodium and 255 mg added sodium prepared in Example 1, the impact of controlling the manufacturing conditions by preconditioning the dough by steam injection before extrusion and increasing the amount of injected steam relative to the amount of injected steam used to precondition a standard added sodium dough expansion ratio of the resulting pellets was investigated.

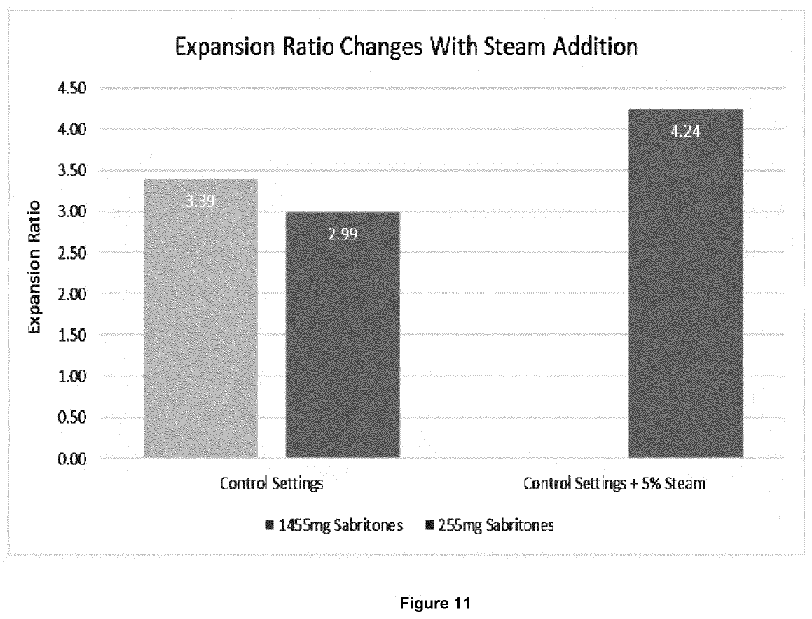

FIG. 11 shows the results of this example. Standard conditions are shown in FIG. 11 as “Control Settings”. These control settings were extrusion at 90° C. and 90 rpm (no steam preconditioning). When the standard added sodium dough is extruded under the control settings, the resulting pellets had an expansion ratio of about 3.39. When the reduced added sodium dough was extruded under the control settings, the resultant pellets had a decreased expansion ratio of about 2.99.

For optimum expansion, it is desirable that the expansion ratio of the reduced added sodium pellets is as close as possible to that of the standard added sodium pellets, preferably within about 5%. To try to achieve this, the reduced added sodium dough was preconditioned with the injection of about 5% steam (on a dry weight basis). This resulted in the expansion ratio of the reduced added sodium pellets increasing to about 4.24, an increase of about 41.8% compared with the same reduced added sodium pellets manufactured under standard conditions. This increase in expansion ratio results in reduced added sodium pellets with an expansion ratio of about 25.1% higher than that of the standard added sodium pellets. Although this is higher than ideally desired, these pellets do not result in poor expanded snack food products, only different ones.

Expansion of the reduced added sodium pellets extruded under manufacturing conditions controlled by preconditioning the dough by adding about 5% steam injection before extrusion had a similar impact to increasing the temperature of the extruder. The resulting pellets produced expanded snack food products with quicker break down in mouth and softer texture.

### Example 9

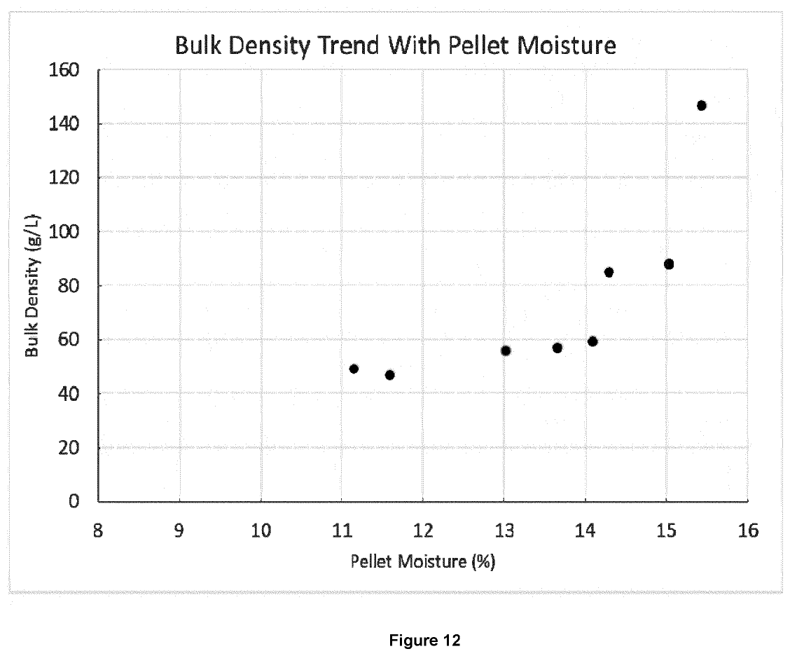

It is generally understood that that expansion of pellets can be improved with increasing pellet moisture. However, it has surprisingly been discovered that increasing the pellet moisture only aids expansion up to a point, after which, expansion of the pellet is negatively impacted. FIG. 12 shows the bulk density impact of expanded snack food products produced from pellets of differing moisture content. It can be seen from FIG. 12 that bulk density favourably decreases when the pellet moisture content is around 11-12% but starts to increase from 13% moisture and there is a big increase in bulk density when the moisture content is increased to around 15.5%.

### Example 10

As a result of the findings of Example 9, an experiment was undertaken to see if decreasing the moisture content of a reduced added sodium dough might impact the bulk density of the resulting expanded snack food.

The doughs comprising 1455 mg added sodium and 255 mg added sodium prepared in Example 1 were used. These doughs had a moisture content of about 34%. Two further reduced added sodium doughs (255 mg added sodium) were prepared by reducing the moisture content of the Example 1 dough to 32% and 31% respectively.

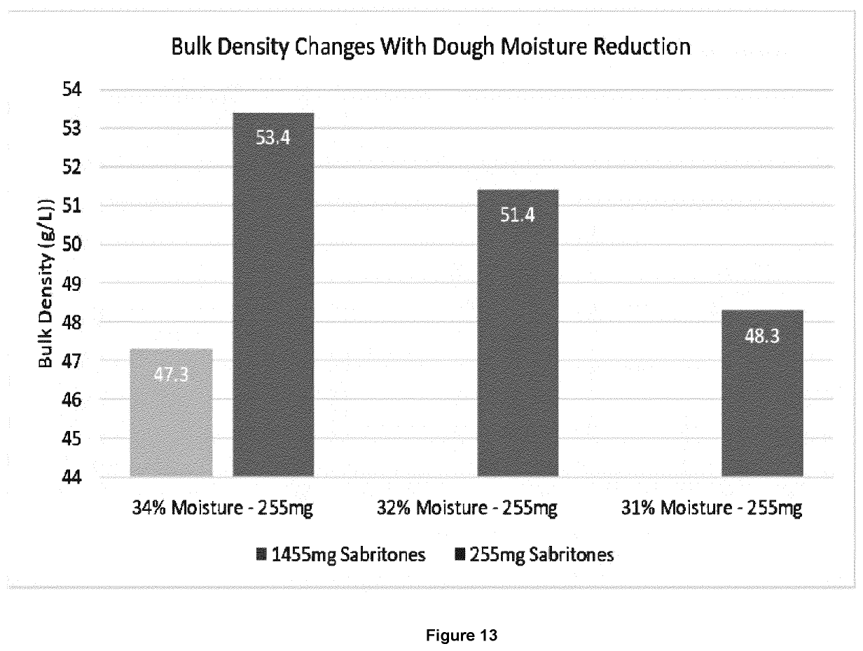

These doughs were then extruded under standard extrusion conditions of extrusion at 90° C. and 90 rpm and the results are shown in FIG. 13. It can be seen that simply reducing added sodium in a dough containing about 34% moisture results in expanded snack food (after frying at 185° C. for 20 seconds) with a bulk density of 53.4 g/L. This is an increase of 12.9% compared with the standard added sodium expanded snack food. However, reducing the moisture content of the reduced added sodium dough by about 2% to about 32%, decreased the bulk density of the resulting expanded snack food to 51.4 g/L. This is a decrease of 3.7% compared with expanded snack food manufactured from the about 34% moisture content reduced added sodium dough. This reduction in bulk density results in reduced added sodium expanded snack food with a bulk density about 8.7% higher than that of standard added sodium expanded snack food.

It was desirable to achieve a bulk density for the reduced added sodium expanded snack food that more closely resembled that of the standard added sodium expanded snack food. Therefore, the moisture content of the reduced added sodium dough was reduced further to about 31% (a reduction of about 3% compared with the standard added sodium dough). This resulted in bulk density of the reduced added sodium expanded snack food being decreased to about 48.3 g/L, a decrease of about 9.6% compared with expanded snack food manufactured from the about 34% moisture content reduced added sodium dough. This reduction in bulk density results in reduced added sodium expanded snack food with a bulk density about 2.1% higher than that of the standard added sodium expanded snack food.

Expansion of the reduced added sodium pellets extruded under manufacturing conditions controlled by decreasing the moisture content of the dough relative to a dough comprising more than 950 mg of added sodium per 100 g of dough produced a softer product which breaks down faster in the mouth. This product was closer to that of a standard added sodium expanded snack food.

### Example 11

In this example, it was investigated why controlling the manufacturing conditions by decreasing the moisture content of the dough results in reduced added sodium pellets and reduced added sodium expanded snack food more closely resembling standard added sodium pellets and standard added sodium snack food.

As outlined above, it was hypothesised that the rheology of the dough changes when added sodium is removed. This results in an extruder screw requiring more force to turn when less added sodium is present. It has surprisingly been found that reducing moisture content of the dough helps to change the rheological properties of the dough such that the force required by the extruder screw is reduced. This is unexpected because generally a dough with less moisture would be more viscous and therefore require more force.

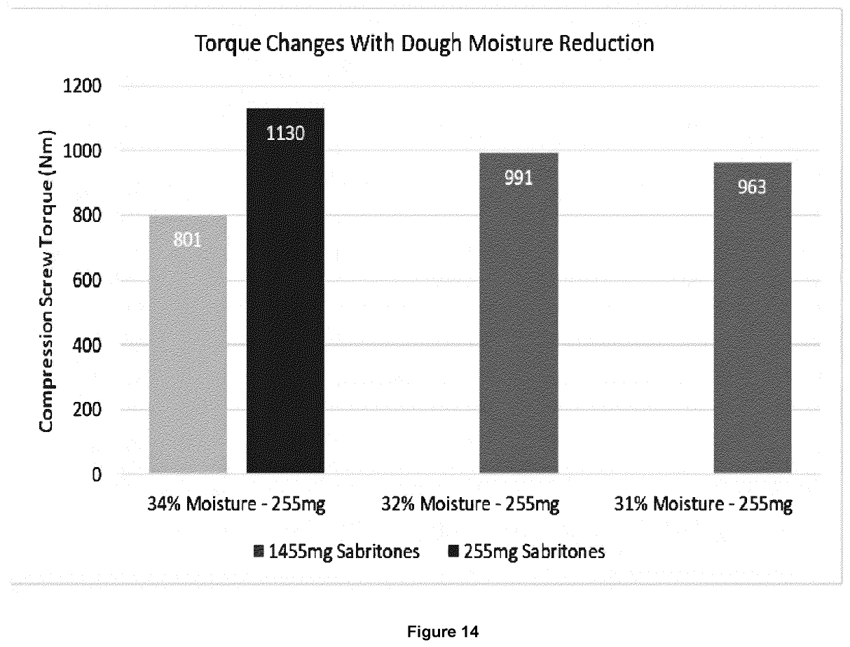

FIG. 14 shows that the torque increased from 801 Nm to 1130 Nm when added sodium is reduced in a dough containing about 34% moisture (1455 mg added sodium compared with 255 mg added sodium). Decreasing the moisture content of the reduced added sodium dough to about 32% decreased the torque required to extrude the reduced added sodium dough to 991 Nm, more closely resembling that of the standard added sodium pellets. Similarly, decreasing the moisture content of the reduced added sodium dough further to about 31% further decreased the torque required to extrude the reduced added sodium dough to 963 Nm, again, more closely resembling that of the standard added sodium pellets.

### Example 12

A standard sodium containing dough was prepared comprising 98.9% corn (maize) flour, 0.5% sodium bicarbonate, 0.5% sodium chloride and 0.1% colouring. A zero added sodium dough was also prepared comprising 99.9% corn (maize) flour and 0.1% colouring.

The sodium containing dough and the zero added sodium doughs were subjected to three different extrusion processing conditions:
Under processing: speed 70 rpm & temperature 115° C.
Reference: speed 80 rpm & temperature 130° C.
Over processing: speed 90 rpm & temperature 140° C.

The extruder used was a single screw cooking extruder manufactured by FEN Italia.

The extruded dough was formed into pellets and dried. The dried pellets were subsequently fried at 140° C.

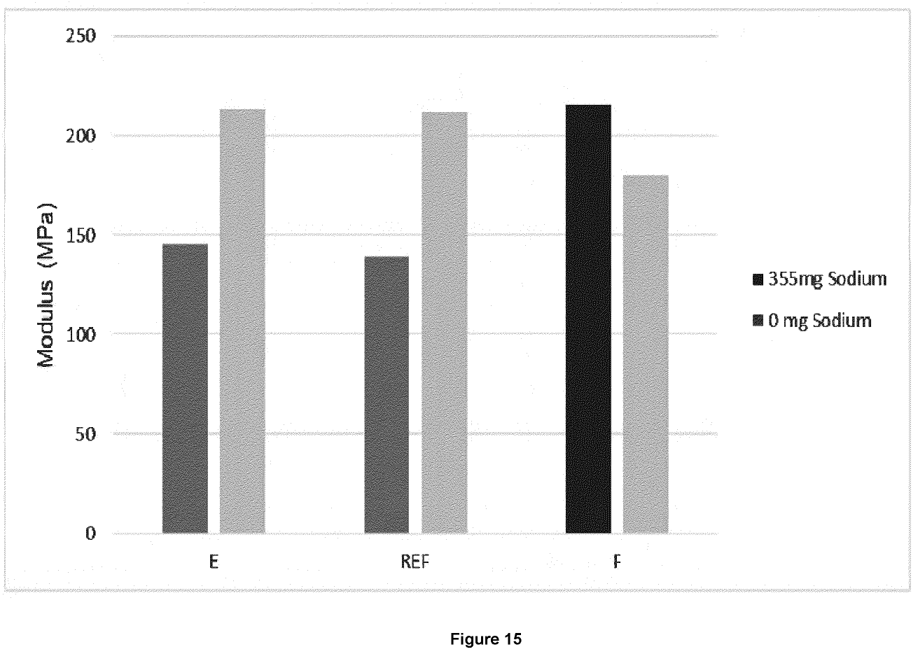

The impact of removing sodium and of the different processing conditions on the rheological properties of the pellets, the microstructure characteristics of the fried products and the frying kinetics can be seen in Table 1 and FIGS. 15-18.

TABLE 1

| | | | Time | | % of | |
|---|---|---|---|---|---|---|
| | | | to | | cells | |
| | Cell | | Expan- | Tensile | under | Aniso- |
| | Size | Modulus | sion | Strength | 200 | trophy |
| Sample | (μm) | (MPa) | (sec) | (MPa) | (μm) | Ratio |
| 2E (with sodium, | 202 | 145 | 40 | 9.4 | 69.6 | 1.52 |
| under processed) | | | | | | |
| 2REF (with sodium, | 270 | 139 | 30 | 4.5 | 58.9 | 1.12 |
| standard settings) | | | | | | |
| 2F (with sodium, | 228 | 211 | 25 | 6.3 | 57.6 | 1.13 |
| over processed) | | | | | | |
| 3E (no sodium, | 239 | 213 | 90 | 8.2 | 55.4 | 1.21 |
| under processed) | | | | | | |
| 3REF (no sodium, | 210 | 211 | 90 | 6.6 | 67.4 | 1.22 |
| standard settings) | | | | | | |
| 3F (no sodium | 250 | 180 | 60 | 8.8 | 59.6 | 1.17 |
| (over processed) | | | | | | |

FIG. 15 shows the impact of removing sodium and of the different processing conditions on the modulus of pellets formed from the extrusion.

Removal of sodium from the dough led to a stiffening of the matrix (pellets 3E, 3Ref and 3F) compared with the standard pellets containing sodium (2E, 2Ref and 3F). This is reflected in both the modulus and the tensile strength values which increase upon removal of sodium.

Under processing either the sodium containing dough (2E) or the zero added sodium dough (3E) also resulted in a slightly increased stiffening/strengthening of the matrix compared with the reference conditions. It is hypothesised that this could be due to the starch being less damaged and gelatinised, reducing the degree of homogeneity in the structure, which in turn increases the strength of the matrix.

However, over processing the zero added sodium dough (3F) resulted in a reduced stiffness/strength matrix compared with the reference conditions (3Ref) and this zero added sodium pellet was the closest to approaching the behaviour of the standard, sodium containing, reference pellet (2Ref) in terms of its rheological properties.

Over processing the sodium containing pellet (2F) led to an increase stiffness compared to the reference conditions (2Ref).

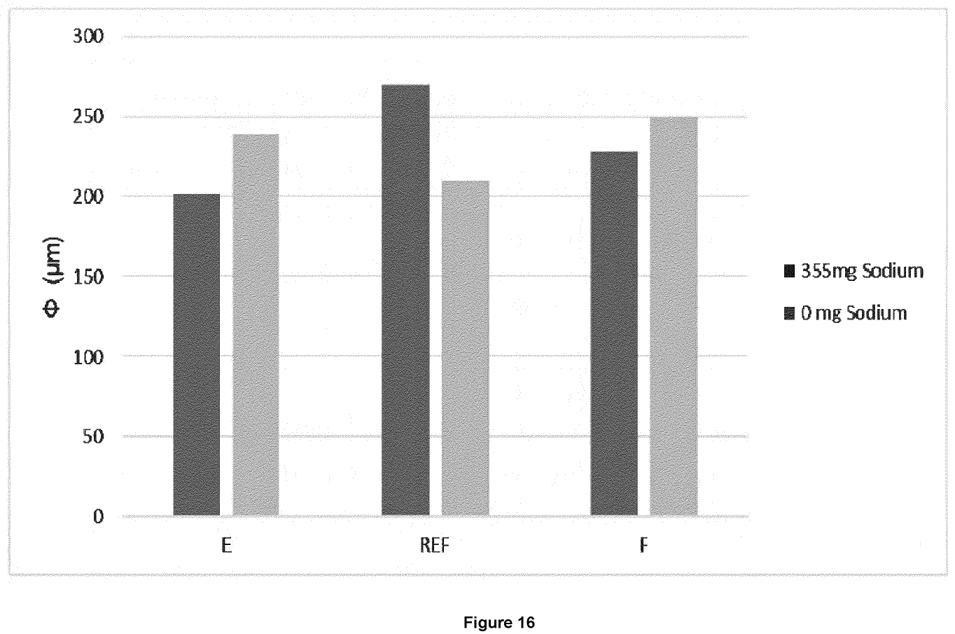

FIG. 16 shows the results of the different processing conditions on the microstructure characteristics of the fried products produced from the extruded pellets.

The removal of sodium resulted in a reduction in cell size when processed under the reference conditions-2Ref (cell size 270 μm) & 3Ref (cell size 210 μm). Also observed was a slightly more homogeneous cellular structure for the zero added sodium pellet (3Ref) and a higher degree of elongation of the cells.

Over processing of the standard, sodium containing, dough led to a decrease in cell size compared to the reference conditions (cell size reduced to 228 μm from 270 μm) and an increased anisotropy ratio. However, over processing the zero added sodium dough increased the cell size compared to the reference conditions (250 μm from 210 μm). Also observed were a lower anisotropy ratio, lower percentage of cells under 200 μm and a more heterogeneous microstructure. The over processed, zero added sodium pellets most closely approach the standard, sodium containing, pellets processed under reference conditions.

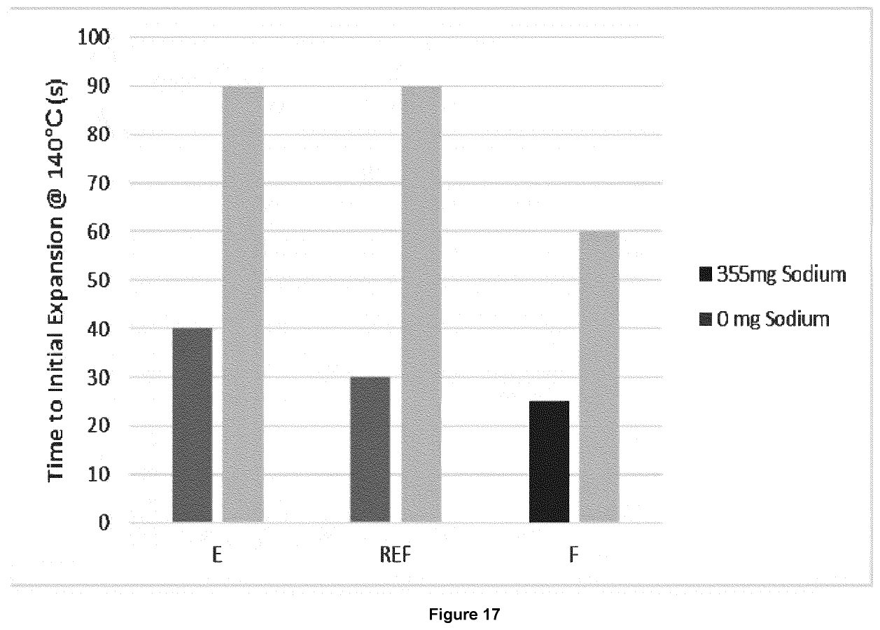

FIG. 17 shows the results of the different processing conditions on the frying kinetics of the pellets. The pellets were fried at 140° C. which, although around 40° C. lower than usual frying temperature, was used to more easily observe the initial expansion of the pellets. It can be seen from FIG. 17 that for zero added sodium pellets under all processing conditions, the time to initial expansion is longer than for standard, sodium containing, pellets under the same conditions. However, it can also be seen that over processing either the zero added sodium dough or the standard, sodium containing, dough produces pellets with a decreased time to expansion. Importantly, for the zero added sodium pellets, over processing conditions decrease the time to expansion to much closer that of the standard, sodium containing, pellet processed under standard conditions (pellet 3F compared with pellet 2Ref).

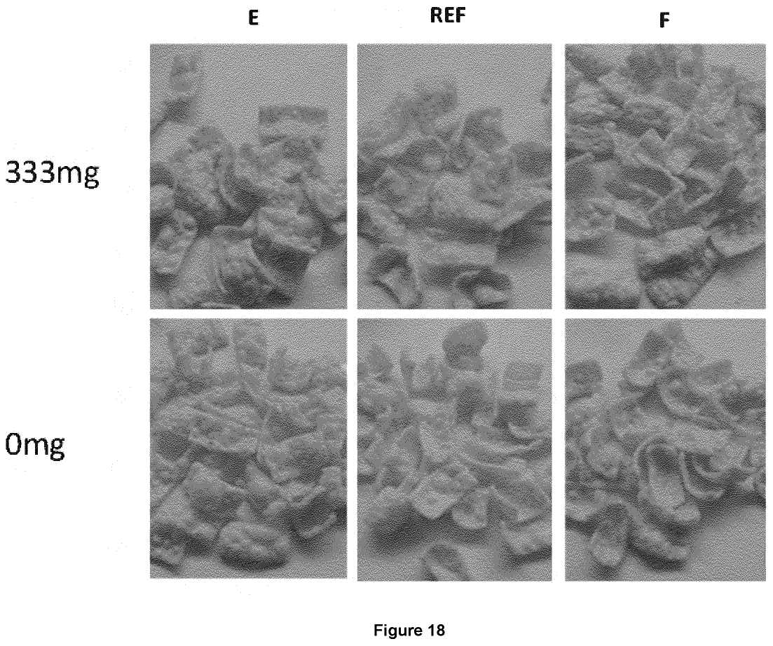

FIG. 18 provides images of the standard, sodium containing, products and the zero added sodium products of this example. However, it should be noted that the differences that can be observed upon consumption cannot always be observed visually.

### Example 13

A zero added sodium dough was prepared comprising 40% chickpea flour, 20.37% rice flour, 5% pre-gelatinised rice flour 25% corn flour and 9.63% tapioca starch.

The impact of different manufacturing conditions (mechanical shear and thermal processing) during formation of pellets on the resultant chickpea fried pellet were tested. The following conditions were explored:
Cell 1: Low Shear Screw Profile (Screw No. 3) at 100° C. and at 50 rpm
Cell 2: Low Shear Screw Profile (Screw No. 3) at 120° C. and at 80 rpm
Cell 3: Medium Shear Screw Profile (Screw No. 6) at 100° C. and at 60 rpm
Cell 4: Medium Shear Screw Profile (Screw No. 6) at 120° C. and at 80 rpm
Cell 5: High Shear Screw Profile (Screw No. 8) at 100° C. and at 60 rpm
Cell 6: High Shear Screw Profile (Screw No. 8) at 120° C. and at 80 rpm

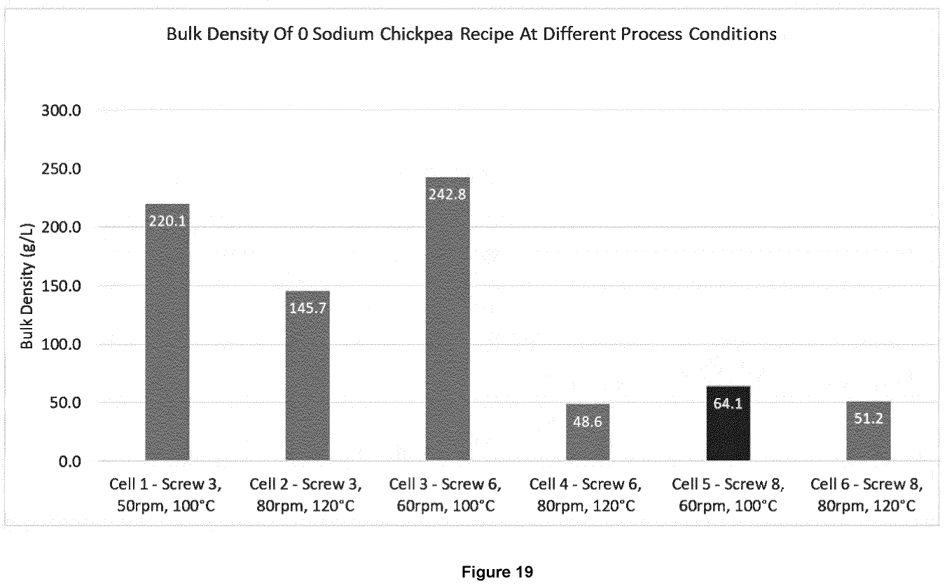

FIG. 19 shows the impact of these different conditions on bulk density of the resulting expanded snack food product. Increasing both the rpm and the temperature of the extruder reduced the bulk density for all Shear Screw Profiles. Changing from a low Shear Screw Profile to a high Shear Screw Profile had a large impact on the bulk density, decreasing it from 220.1 (Cell 1) to 64.1 (Cell 5) and from 145.7 (Cell 2) to 51.2 (Cell 6).

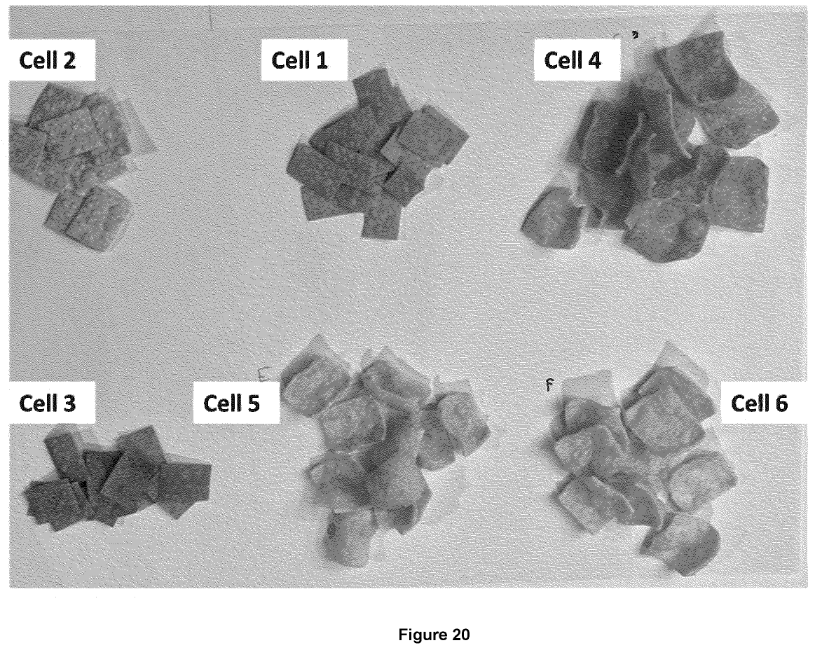

FIG. 20 is an image visually showing the differences in the chickpea fried pellet prepared by each of the above conditions. It can be seen that the product of Cell 3 which had the highest bulk density, is hard, crunchy and dense. In contrast the products of Cells 4-6 which had the lowest bulk density, are light and soft.

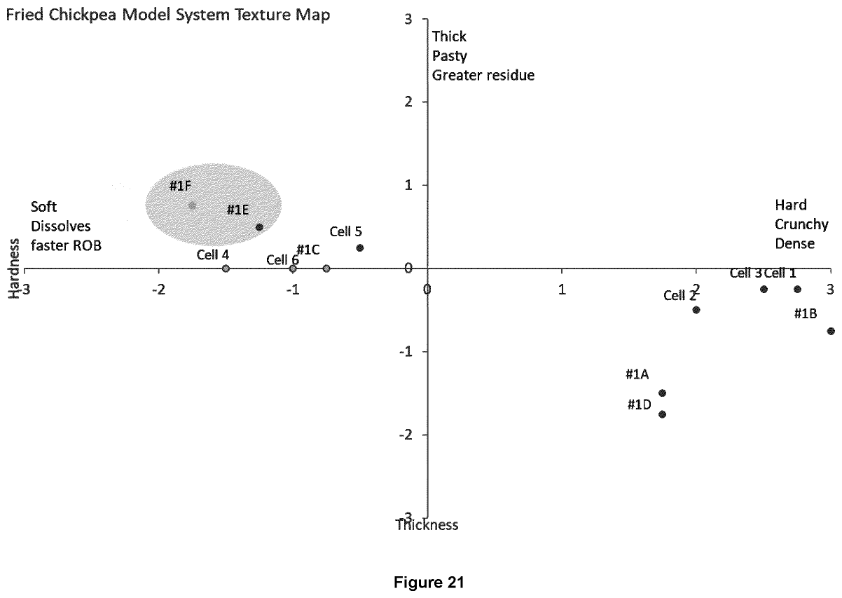

FIG. 21 is a sensory map depicting how increasing mechanical and thermal processing of the zero added sodium chickpea pellets can improve product texture from being hard, crunchy and dense with a slow breakdown in the mouth to the opposite, products that have a soft first bite and fast rate of breakdown leading to a clean eat.

### Example 14

A standard sodium containing dough was prepared comprising 38% chickpea flour, 5% Yellow corn flour 355, 20% Rice Flour, 10% Tapioca Starch, 5% pregelatinized rice flour, Salt 2%. The dough contained 787 mg of added sodium per 100 g of dough. A zero added sodium containing dough was also prepared comprising 40% Chickpea flour, 25% Yellow corn flour 355, 20% Rice Flour, 10% Tapioca Starch, 5% pregelatinized rice flour. This dough contained Omg added sodium per 100 g. Both doughs had moisture content of 33.5%.

The impact of controlling the manufacturing conditions by increasing the temperature of the extruder used to extrude the doughs on bulk density of the resulting expanded snack food was investigated.

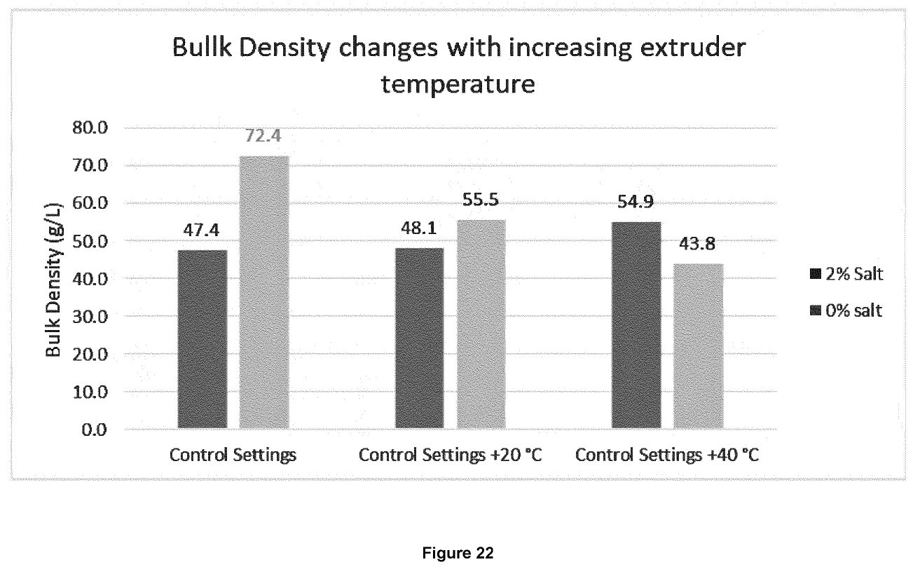

FIG. 22 shows the results of this example. Standard conditions are shown in FIG. 22 as “Control Settings”. These control settings were extrusion at 80° C. and 60 rpm (Screw 6). When the standard added sodium dough was extruded under the control settings, the resulting expanded snack food (after frying at 185° C. for 16 seconds) had a bulk density of about 47.4 g/L. When the zero added sodium dough was extruded under the control settings, the resultant expanded snack food had an increased bulk density of about 72.4 g/L.

The temperature of the extruder was increased by 20° C. to 100° C. This resulted in the zero added sodium snack food having a decreased bulk density of 55.5 g/L, a decrease of about 23.3% compared to the same zero added sodium snack food manufactured under standard conditions. This reduction in bulk density results in a zero added sodium expanded snack food with a bulk density about 17% higher than that of the standard added sodium expanded snack food.

It was desirable to achieve a bulk density for the zero added sodium expanded snack food that more closely resembled that of the standard added sodium expanded snack food. Therefore, the temperature of the extruder was increased further, this time by 40° C. to 120° C., an increase of 50% compared to the control setting. This resulted in the bulk density of the zero added sodium expanded snack food being decreased to about 43.8 g/L, a decrease of about 39.5% compared with the same zero added sodium expanded snack food manufactured under standard conditions. This reduction in bulk density results in reduced added sodium expanded snack food with a bulk density about 7.6% lower than that of the standard added sodium expanded snack food.

Expansion of the zero added sodium pellets extruded under manufacturing conditions controlled by increasing the temperature of the extruder by 20° C. or 40° C. compared to standard conditions provided expanded snack food products with surface and internal bubble structure that was closely resembled the structure of standard added sodium pellets.

When samples were assessed by an expert panel the zero sodium recipe when processed with the 40° C. increase in the extruder temperature was found to be closest to the standard sodium product.

### Example 15

Using the chickpea doughs comprising 787 mg of added sodium and zero added sodium prepared in Example 14, the impact of controlling the manufacturing conditions by increasing the temperature of the extruder used to extrude the doughs on expansion ratio of the resulting pellets was investigated.

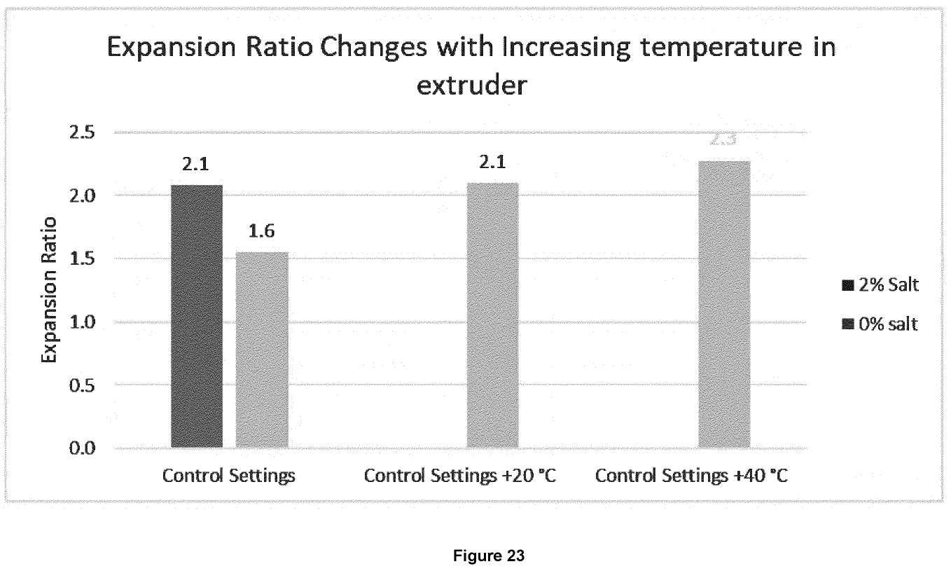

FIG. 23 shows the results of this example. Standard conditions are shown in FIG. 23 as “Control Settings”. These control settings were extrusion at 80° C. and 60 rpm. When the standard added sodium dough is extruded under the control settings, the resulting pellets had an expansion ratio of about 2.1. When the zero added sodium dough was extruded under the control settings, the resultant pellets had a decreased expansion ratio of about 1.6.

For optimum expansion, it is desirable that the expansion ratio of the zero added sodium pellets is as close as possible to that of the standard added sodium pellets, preferably within about 5%. To try to achieve this, the temperature of the extruder was increased by 20° C. to 100° C., an increase of 25% compared to the control setting. This resulted in the expansion ratio of the zero added sodium pellets increasing to about 2.1, an increase of about 31.3% compared with the same zero added sodium pellets manufactured under standard conditions. This increase in expansion ratio results in zero added sodium pellets with an expansion ratio of the same as that of the standard added sodium pellets.

The temperature of the extruder was increased further, this time by 40° C. to 120° C., an increase of 50% compared to the control setting. This resulted in the expansion ratio of the zero added sodium pellets being increased to about 2.3, an increase of about 43.8% compared with the same zero added sodium pellets manufactured under standard conditions. This reduction in expansion ratio results in zero added sodium pellets with an expansion ratio about 9.5% higher than that of the standard added sodium pellets.

Expansion of the zero added sodium pellets extruded under manufacturing conditions controlled by increasing the temperature of the extruder by 20° C. or 40° C. compared to standard conditions provided expanded snack food products with surface and internal bubble structure that was closely resembled the structure of standard added sodium pellets.

When samples were assessed by an expert panel the zero sodium recipe when processed with the 40° C. increase in the extruder temperature was found to be closest to the standard sodium product.

For the avoidance of any doubt, the terms “a”, “an” and “the” are intended, unless specifically indicated otherwise or the context requires otherwise, to include plural alternatives, e.g., at least one.

“Optional” or “optionally” means that the subsequently described event or circumstance can or cannot occur, and that the description includes instances where the event or circumstance occurs and instances where it does not.

Various other modifications to the present invention will be readily apparent to those skilled in the art.

1. A method for manufacturing a reduced or zero added sodium expandable snack food pellet comprising:
providing a dough comprising less than about 300 mg of added sodium per 100 g of dough;
extruding the dough through an extruder to produce an extrudate;
forming the extrudate into pellets; and
drying the pellets;
wherein the manufacturing conditions are controlled to increase the expansion ratio of the pellet by about 5% to about 45% relative to the same pellet manufactured under standard conditions.

2. A method for manufacturing a reduced or zero added sodium expanded snack food comprising:
providing a dough comprising less than about 300 mg of added sodium per 100 g of dough;
extruding the dough through an extruder to produce an extrudate;
forming the extrudate into pellets;
drying the pellets; and
cooking the pellets;
wherein the manufacturing conditions are controlled to decrease the bulk density of the snack food by about 5% to about 40% relative to the same snack food manufactured under standard conditions.

3. The method according to claim 1, wherein the manufacturing conditions are controlled by:
(a) increasing the temperature of the extruder relative to the temperature of an extruder used to extrude a dough comprising at least about 950 mg of added sodium per 100 g of dough; and/or
(b) increasing the speed of the extruder relative to the speed of an extruder used to extrude a dough comprising at least about 950 mg of added sodium per 100 g of dough; and/or
(c) decreasing the moisture content of the dough relative to a dough comprising at least about 950 mg of added sodium per 100 g of dough; and/or
(d) preconditioning the dough by steam injection before extrusion and increasing the amount of injected steam relative to the amount of injected steam used to precondition a dough comprising at least about 950 mg of added sodium per 100 g of dough.

4. The method according to claim 3, wherein increasing the temperature of the extruder decreases the bulk density of the snack food by about 5% to about 30%; and/or increases the expansion ratio of the snack food pellet by about 5% to about 30%.

5. The method according to claim 3, wherein increasing the speed of the extruder decreases the bulk density of the snack food by about 5% to about 20%.

6. The method according to claim 3, wherein decreasing the moisture content of the dough decreases the bulk density of the snack food by about 5% to about 15%.

7. The method according to claim 3, wherein increasing the amount of injected steam decreases the bulk density of the snack food by about 5% to about 20%; and/or increases the expansion ratio of the snack food pellet by about 5% to about 40%.

8. The method according to claim 3, wherein the temperature of the extruder is increased by about 5% to about 45%, relative to the temperature of an extruder used to extrude a dough comprising at least about 950 mg of added sodium per 100 g of dough.

9. The method according to claim 3, wherein the speed of the extruder is increased by about 5% to about 50%, relative to the speed of an extruder used to extrude a dough comprising at least about 950 mg of added sodium per 100 g of dough.

10. The method according to claim 3, wherein the moisture content of the dough is decreased by about 0.5 wt % to about 6 wt %, relative to a dough comprising at least about 950 mg of added sodium per 100 g of dough.

11. The method according to claim 3, wherein amount of steam injected is increased by about 1% to about 20%, relative to the amount of injected steam used to precondition a dough comprising at least about 950 mg of added sodium per 100 g of dough.

12. The method according to claim 3, wherein the temperature of the extruder is increased by about 5° C. to about 50° C. relative to the temperature of an extruder used to extrude a dough comprising at least about 950 mg of added sodium per 100 g of dough.

13. The method according to claim 3, wherein the speed of the extruder is increased by about 10 rpm to about 40 rpm relative to the speed of an extruder used to extrude a dough comprising at least about 950 mg of added sodium per 100 g of dough.

14. The method according to claim 1, wherein the dough comprises potato based starch.

15. The method according to claim 14, wherein the manufacturing conditions are controlled by:
(i) increasing the temperature of the extruder by at least about 15%, relative to the temperature of an extruder used to extrude a dough comprising at least about 950 mg of added sodium per 100 g of dough; and/or
(ii) increasing the speed of the extruder by at least about 20%, relative to the speed of an extruder used to extrude a dough comprising at least about 950 mg of added sodium per 100 g of dough.

16. The method according to claim 14, wherein the pellet has a heterogeneous starch-based matrix.

17. The method according to claim 1, wherein the dough comprises grain based starch.

18. The method according to claim 17, wherein the manufacturing conditions are controlled by:
(i) increasing the temperature of the extruder by at least about 5%, relative to the temperature of an extruder used to extrude a dough comprising at least about 950 mg of added sodium per 100 g of dough; and/or
(ii) increasing the speed of the extruder by at least about 8%, relative to the speed of an extruder used to extrude a dough comprising at least about 950 mg of added sodium per 100 g of dough.

19. The method according to claim 17, wherein the pellet has a homogeneous starch-based matrix.

20. The method according to claim 3, wherein increasing the temperature and/or speed of the extruder and/or decreasing the moisture content of the dough and/or increasing the amount of injected steam lowers the glass transition temperature such that the extrudate has a lower glass transition temperature than the dough.

21. The method according to claim 1, wherein the dough comprises less than about 250 mg of added sodium per 100 g of dough.

22. The method according to claim 1, wherein the dough comprises zero added sodium per 100 g of dough.

23. A method for manufacturing a reduced or zero added sodium expandable snack food pellet comprising:
providing a dough comprising less than about 300 mg of added sodium per 100 g of dough;
extruding the dough through an extruder to produce an extrudate;
forming the extrudate into pellets; and
drying the pellets;
wherein the manufacturing conditions are controlled to provide a pellet having an expansion ratio which is about ±10%, of the expansion ratio of a comparable pellet comprising at least about 950 mg of added sodium per 100 g of pellets.

24. (canceled)

25. A reduced or zero added sodium expandable snack food pellet comprising less than about 300 mg added sodium per 100 g of pellets, wherein each pellet has a glass transition temperature of less than about 80° C.

26. A reduced or zero added sodium expandable snack food pellet comprising less than about 300 mg added sodium per 100 g of pellets, wherein the pellet has an expansion ratio which is about ±10%, of the expansion ratio of a comparable pellet comprising at least about 950 mg of added sodium per 100 g of pellets.

27. (canceled)

28. A method for manufacturing a reduced or zero added sodium expanded snack food comprising:
providing a dough comprising less than about 300 mg of added sodium per 100 g of dough;
extruding the dough through an extruder to produce an extrudate;
forming the extrudate into pellets;
drying the pellets; and
cooking the pellets;
wherein the manufacturing conditions are controlled to provide a snack food having a bulk density which is about ±10% of the bulk density of a comparable snack food comprising at least about 950 mg of added sodium per 100 g of pellets.

29. (canceled)

30. A reduced or zero added sodium expanded snack food, wherein the snack food has a bulk density which is about ±10% of the bulk density of a comparable snack food comprising at least about 950 mg of added sodium per 100 g of snack food.

31. (canceled)
